(19) United States
(12) Patent Application Publication
(10) Pub. No.: US 2018/0367614 A1
(43) Pub. Date: Dec. 20, 2018

(54) SYSTEMS AND METHODS FOR COMMUNICATING VIA A TRACK WITH AN INDUSTRIAL CART

(71) Applicant: Grow Solutions Tech LLC, Lehi, UT (US)

(72) Inventor: Gary Bret Millar, Highland, UT (US)

(73) Assignee: Grow Solutions Tech LLC, Lehi, UT (US)

(21) Appl. No.: 15/985,164

(22) Filed: May 21, 2018

Related U.S. Application Data
(60) Provisional application No. 62/519,304, filed on Jun. 14, 2017.
(60) Provisional application No. 62/519,329, filed on Jun. 14, 2017.
(60) Provisional application No. 62/519,326, filed on Jun. 14, 2017.
(60) Provisional application No. 62/519,316, filed on Jun. 14, 2017.

(51) Int. Cl. H04L 29/08; H04B 3/54; H04L 12/28; H04L 12/861

(52) U.S. Cl. CPC H04L 67/12; H04B 3/542; E01B 25/28; H04L 49/90; H04L 12/2858

(57) ABSTRACT

A system includes a track having conductive rails, a signal generating circuit coupled to the conductive rails, and an electrical power source coupled to the conductive rails via the signal generating circuit. The signal generating circuit includes a power supply for generating trigger signals. The electrical power source provides an electrical signal to the conductive rails via the signal generating circuit. The signal generating circuit generates a first trigger signal within the electrical signal at a first time interval and generates a second trigger signal within the electrical signal at a second time interval. The first trigger signal corresponds to a beginning of a communication signal and the second trigger signal corresponds to an end of the communication signal. The communication signal is transmitted over a predetermined number of cycles of the electrical signal provided by the electrical power source. The predetermined number of cycles correspond to a coded communication.

### CROSS-REFERENCE TO RELATED APPLICATIONS

This application clams the benefit of U.S. Provisional Application No. 62/519,304, filed Jun. 14, 2017, the benefit of U.S. Provisional Application No. 62/519,329, filed Jun. 14, 2017, the benefit of U.S. Provisional Application No. 62/519,326, filed Jun. 14, 2017, the benefit of U.S. application Ser. No. 15/934,436, filed Mar. 23, 2018, the benefit of U.S. Provisional Application No. 62/519,316, filed Jun. 14, 2017, and the benefit of U.S. application Ser. No. 15/937,108, filed Mar. 27, 2018, the contents of which are hereby incorporated by reference in their respective entireties.

### TECHNICAL FIELD

Embodiments described herein generally relate to systems and methods for communicating with a cart via a track and, more specifically, to systems and methods for providing communications and electrical power via a track to a cart in an assembly line configuration of a grow pod.

### BACKGROUND

Assembly line systems generally provide communication signals and electrical signals to components of the assembly line through independent means. However, some systems attempt to embed communication signals within electrical signals. These systems may optimize the number of conductors required to complete the tasks of communication and power delivery, but require specialized equipment and costly equipment.

The present disclosure is an extension of the concept of embedding communication signals within electrical signals, while providing improved, less complex, and unique systems and methods for providing communication signals and electrical signals to components coupled to a common conductor in an assembly line system.

### SUMMARY

In one embodiment, a system includes a length of track having one or more conductive rails, a signal generating circuit electrically coupled to the one or more conductive rails of the length of track, and an electrical power source electrically coupled to the one or more conductive rails of the length of track via the signal generating circuit. The signal generating circuit includes a power supply for generating a plurality of trigger signals. The electrical power source provides an alternating current electrical signal to the one or more conductive rails of the length of track via the signal generating circuit. The signal generating circuit generates a first trigger signal within the alternating current electrical signal at a first time interval and generates a second trigger signal within the alternating current electrical signal at a second time interval. The first trigger signal corresponds to a beginning of a communication signal and the second trigger signal corresponds to an end of the communication signal. The communication signal is transmitted over a predetermined number of cycles of the alternating current electrical signal provided by the electrical power source. The predetermined number of cycles correspond to a coded communication.

In another embodiment, a system includes a length of track having one or more conductive rails, an electrical power source electrically coupled to the one or more conductive rails of the length of track, and a cart. The cart includes a wheel supported on the length of track and electrically coupled to the one or more conductive rails of the length of track, a cart-computing device communicatively coupled to the wheel, and a signal generating circuit electrically coupled to the cart-computing device and the wheel. The signal generating circuit includes a power supply for generating a plurality of trigger signals. The electrical power source provides an alternating current electrical signal to the one or more conductive rails of the length of track. The signal generating circuit generates a first trigger signal within the alternating current electrical signal at a first time interval and generates a second trigger signal within the alternating current electrical signal at a second time interval. The first trigger signal corresponds to a beginning of a communication signal and the second trigger signal corresponds to an end of the communication signal. The communication signal is transmitted over a predetermined number of cycles of the alternating current electrical signal provided by the electrical power source. The predetermined number of cycles correspond to a coded communication.

In another embodiment, a method for communicating via an alternating current electrical signal from a master controller to a cart supported on a length of track in an assembly line grow pod includes determining, by the master controller, an action to be completed by the cart, generating one or more coded communications for the action, and generating a first trigger signal within the alternating current electrical signal from an electrical power source. The method further includes determining when a predetermined number of cycles of the alternating current electrical signal corresponding to a coded communication of the one or more coded communications have propagated from the electrical power source following the first trigger signal and generating a second trigger signal within the alternating current electrical signal when the predetermined number of cycles of the alternating current electrical signal corresponding to the coded communication have propagated following the first trigger signal.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an illustrative assembly line grow pod that includes a plurality of carts according to embodiments described herein;

FIG. 2 depicts an illustrative network environment for various components in an assembly line grow pod according to embodiments described herein;

FIG. 3 depicts a plurality of illustrative carts supporting a payload in an assembly line configuration according to embodiments described herein;

FIG. 4 depicts various components of an illustrative cart-computing device for facilitating communications according to embodiments described herein;

FIG. 5A depicts a portion of a signal generating circuit according to embodiments described herein;

FIG. 5B depicts the TRIAC circuit of a signal generating circuit according to embodiments described herein;

FIG. 5C depicts the solid state circuit of a signal generating circuit according to embodiments described herein;

FIG. 6A depicts a circuit diagram of illustrative sub-circuits of electronics for a cart-computing device according to embodiments described herein;

FIG. 6B depicts a circuit diagram of illustrative sub-circuits of electronics for a cart-computing device according to embodiments described herein;

FIG. 6C depicts a circuit diagram of illustrative sub-circuits of electronics for a cart-computing device according to embodiments described herein;

FIG. 6D depicts a circuit diagram of illustrative sub-circuits of electronics for a cart-computing device according to embodiments described herein;

FIG. 6E depicts a circuit diagram of illustrative sub-circuits of electronics for a cart-computing device according to embodiments described herein;

FIG. 7A depicts an electrical power waveform provided by an electrical power source according to embodiments described herein;

FIG. 7B depicts a communication signal within an electrical power waveform according to embodiments described herein;

FIG. 7C depicts another communication signal within an electrical power waveform according to embodiments described herein;

FIG. 7D depicts another communication signal within an electrical power waveform according to embodiments described herein;

FIG. 7E depicts another communication signal within an electrical power waveform according to embodiments described herein; and

FIG. 8 depicts a flowchart of a method for providing a communication signal within an electrical signal according to embodiments described herein.

### DETAILED DESCRIPTION

Embodiments disclosed herein generally include systems and methods for providing communications and electrical power via a track to a cart in an assembly line configuration of a grow pod. Some embodiments are configured such that a cart supporting a payload travels on a track of a grow pod to provide sustenance (such as light, water, nutrients, etc.) to seeds and/or plants included in the payload on the cart. The cart may be among one or more other carts arranged on the track of the grow pod to create an assembly line of carts. The cart, via the wheels and track, receive power and communication signals. In embodiments described herein, the power and communication signals may be transmitted over common conductors, for example, the track and wheels of the cart, thereby removing the need for separate systems and components that may be required for separate power and communication transmission systems.

In some embodiments, the assembly line may have a shared power delivery system for the components coupled to the assembly line. Depending on the type of electrical signal implemented, various types of communication protocols may be implemented to embed communication signals with the electrical signal. Digital command control (DCC) is one example. DCC provides for the communication of commands by modulating the width of voltage signals within the electrical signal to indicate a binary 1 or a binary 0. As a result, communications may be provided to all or select components sharing the common conductor. While DDC is one example system and method, other systems utilize pulses of voltage that oppose the polarity of the electrical signal to generate communication signals within an electrical signal. Furthermore, by introducing DC pulses during a zero-crossing of an alternating current electrical signal, adjusting the peak voltage of the alternating current electrical signal, introducing a delay to the repeating waveform of the alternating current electrical signal, or the like may be additional methods of generating a communication signal within an electrical signal.

For example, the track may be coupled to a power source, such as the output of a transformer by way of a signal generating circuit. The signal generating circuit, which may include or be coupled to a master controller, may be electrically coupled to the output of the transformer and to the track. The signal generating circuit may be configured to introduce a pulse (e.g., a DC voltage pulse) during the zero-crossing of an alternating current electrical signal from the transformer and/or electrical power source. As a result, a communication signal may be generated within the electrical signal transmitted to the track. Furthermore, the cart may also transmit communication signals via the wheels and the track to a communicatively coupled master controller or another cart on the track.

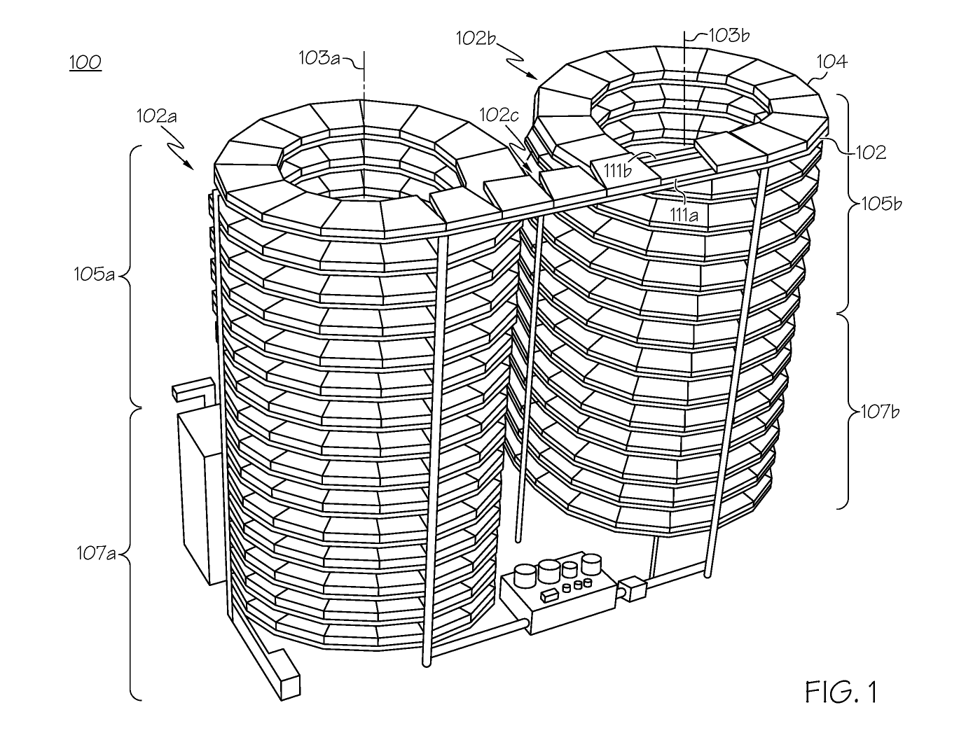

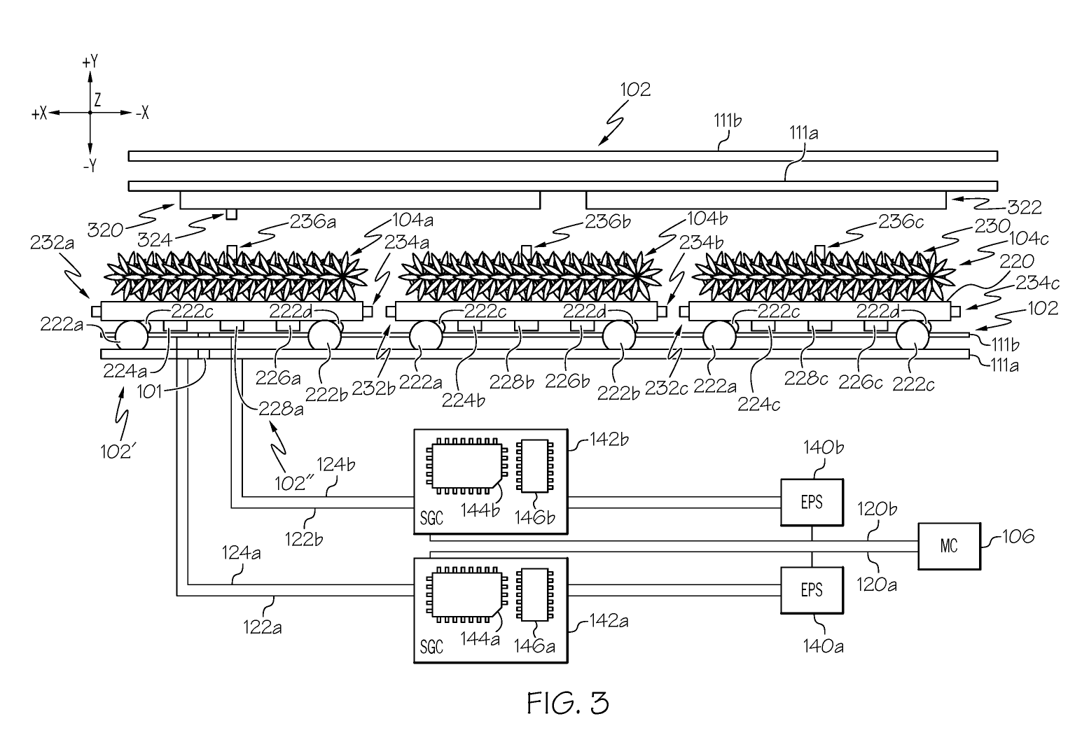

Referring now to the drawings, FIG. 1 depicts an illustrative assembly line grow pod 100 that includes a plurality of carts 104. As illustrated, the assembly line grow pod 100 includes a track 102 that supports one or more carts 104. Each of the one or more carts 104, as described in more detail with reference to at least FIG. 3, may include one or more wheels 222a-222d (collectively, referred to as 222) rotatably coupled to the cart 104 and supported on the track 102. For example, the first cart 104a includes one or more first wheels 222, individually a first wheel 222a, a second wheel 222b, a third wheel 222c, and a fourth wheel 222d of the first cart 104a. The second cart 104b includes one or more second wheels 222, individually a first wheel 222a, a second wheel 222b, a third wheel 222c, and a fourth wheel 222d of the second cart 104b. Additionally, the third cart 104c includes one or more third wheels 222, individually a first wheel 222a, a second wheel 222b, a third wheel 222c, and a fourth wheel 222d of the third cart 104c.

Still referring to FIG. 1, the track 102 may include an ascending portion 102a, a descending portion 102b, and a connection portion 102c. The ascending portion 102a may be coupled to the descending portion 102b via the connection portion 102c. The track 102 may wrap around (e.g., in a counterclockwise direction as depicted in FIG. 1) a first axis 103a such that the carts 104 ascend upward in a vertical direction. The connection portion 102c may be relatively level and straight (although these are not requirements). The connection portion 102c is utilized to transfer the carts 104 from the ascending portion 102a to the descending portion 102b. The descending portion 102b may be wrapped around a second axis 103b (e.g., in a counterclockwise direction as depicted in FIG. 1) that is substantially parallel to the first axis 103a, such that the carts 104 may be returned closer to ground level. Each of the ascending portion 102a and the descending portion 102b includes an upper portion 105a and 105b, respectively, and a lower portion 107a and 107b, respectively. In some embodiments, a second connection portion (not shown in FIG. 1) may be positioned near ground level that couples the descending portion 102b to the ascending portion 102a such that the carts 104 may be transferred from the descending portion 102b to the ascending portion 102a. Similarly, some embodiments may include more than two connection portions 102c to allow different carts 104 to travel different paths. As an example, some carts 104 may continue traveling up the ascending portion 102a, while some may take one of the connection portions 102c before reaching the top of the assembly line grow pod 100.

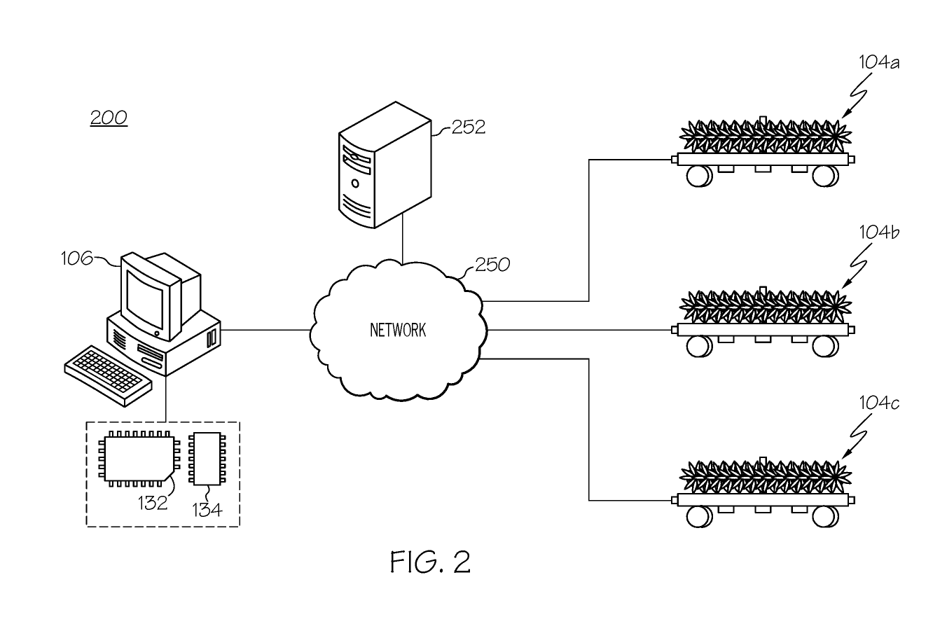

FIG. 2 depicts an illustrative network environment 200 for a cart 104 in a grow house. As illustrated, each of a plurality of carts 104 (e.g., a first cart 104a, a second cart 104b, and a third cart 104c and collectively referred to herein as cart(s) 104) may be communicatively coupled to a network 250. Additionally, the network 250 may be communicatively coupled to a master controller 106 and/or a remote computing device 252. The master controller 106 may be configured to communicate with and control various components of the assembly line grow pod 100 including the plurality of carts 104, as described in greater detail herein.

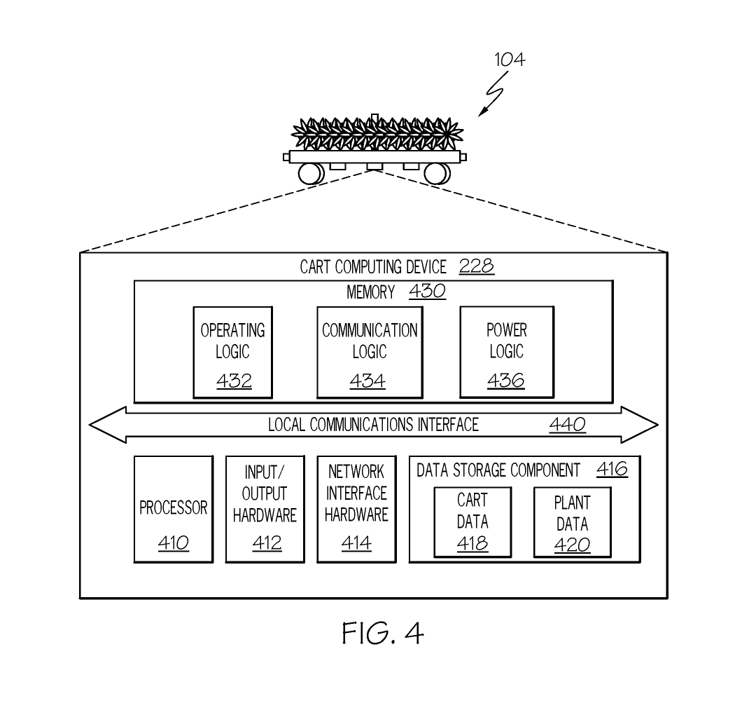

The remote computing device 252 may be a personal computer, laptop, mobile device, tablet, server, etc. and may be utilized to control operation of the components of the assembly line grow pod 100 and/or as an interface to the assembly line grow pod 100 for a user. The remote computing device 252 may include a processor 132 and a non-transitory, computer readable memory 134. The processor 132 may include any processing component operable to receive and execute instructions such as from the non-transitory, computer readable memory 134. The processor 132 may be any device capable of executing the machine-readable instruction set stored in the non-transitory, computer readable memory 134. Accordingly, the processor 132 may be an electric controller, an integrated circuit, a microchip, a computer, or any other computing device. The non-transitory, computer readable memory 134 may be any component capable of storing electronic information, for example, such as the memory component 430 described herein with reference to FIG. 4. Depending on the embodiment, the master controller 106 may be integrated as part of the assembly line grow pod 100 or may be communicatively coupled to the assembly line grow pod 100 and/or one or more components thereof. For example, a cart 104 may send a notification to a user through the remote computing device 252 and/or the master controller 106.

Similarly, the master controller 106 may include a server, personal computer, tablet, mobile device, etc. and may be utilized for machine-to-machine communications. As an example, if the cart 104 (and/or assembly line grow pod 100 from FIG. 1) determines that a type of seed being used requires a specific configuration for the assembly line grow pod 100 to increase plant growth or output (e.g., through the cart-computing device 228 and/or one or more sensor modules e.g., 232, 234, 236 of the carts 104 depicted in FIG. 3), then the cart 104 may communicate with the master controller 106 and/or the remote computing device 252 to retrieve the desired data and/or settings for the specific configuration.

The desired data may include a recipe for growing that type of seed and/or other information. The recipe may include time limits for exposure to light, amounts of water and the frequency of watering, environmental conditions such as temperature and humidity, and/or the like. The cart 104 may further query the master controller 106 and/or remote computing device 252 for information such as ambient conditions, firmware updates, etc. Likewise, the master controller 106 and/or the remote computing device 252 may provide one or more instructions in a communication signal to the cart 104 that includes control parameters for the drive motor 226. As such, some embodiments may utilize an application program interface (API) to facilitate this or other computer-to-computer communications.

The network 250 may include the internet or other wide area network, a local network, such as a local area network, a near field network, such as Bluetooth or a near field communication (NFC) network. In some embodiments, the network 250 is a personal area network that utilizes Bluetooth technology to communicatively couple the master controller 106, the remote computing device 252, one or more carts 104, and/or any other network connectable device. In some embodiments, the network 250 may include one or more computer networks (e.g., a personal area network, a local area network, or a wide area network), cellular networks, satellite networks and/or a global positioning system and combinations thereof. Accordingly, at least the one or more carts 104 may be communicatively coupled to the network 250 via the electrically conductive track 102, via wires, via a wide area network, via a local area network, via a personal area network, via a cellular network, via a satellite network, and/or the like. Suitable local area networks may include wired Ethernet and/or wireless technologies such as, for example, Wi-Fi. Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Communications between the various components of the network environment 200 may be facilitated by various components of the assembly line grow pod 100 (FIG. 1). For example, the track 102 (FIG. 1) may include one or more conductive rails that support the cart 104 and are communicatively coupled to the master controller 106 and/or remote computing device 252 through the network 250 as shown in FIGS. 1 and 2. Referring now to FIG. 3, the track 102 includes at least two conductive rails 111a and 111b, in some embodiments. Each of the two conductive rails 111a and 111b of the track 102 may be electrically conductive. Each conductive rail 111 may be configured for transmitting communication signals and electrical power to and from the cart 104 via the one or more wheels 222 rotatably coupled to the cart 104 and supported by the track 102. That is, a portion of the track 102 is electrically conductive and a portion of the one or more wheels 222 is in electrical contact with the portion of the track 102 that is electrically conductive. Although reference herein is made to a track 102 including one or more conductive rails, it should be understood that the one or more conductive rails may be any form and type of conductor which is capable of conducting electrical signals and/or communication signals.

Still referring to FIG. 3, a plurality of illustrative carts 104 (e.g., the first cart 104a, the second cart 104b, and the third cart 104c), each supporting a payload 230 in an assembly line configuration on the track 102, is depicted. In some embodiments, the track 102 may include one conductive rail and one wheel 222 in electrical contact with the one conductive rail. In such an embodiment, the one wheel 222 may relay communication signals and electrical power to the cart 104 as the cart 104 travels along the track 102.

Since the carts 104 are limited to travel along the track 102, the area of track 102 a cart 104 will travel in the future is referred to herein as “in front of the cart” or “leading.” Similarly, the area of track 102 a cart 104 has previously traveled is referred to herein as “behind the cart” or “trailing.” Furthermore, as used herein, “above” refers to the area extending from the cart 104 away from the track 102 (i.e., in the +Y direction of the coordinate axes of FIG. 3). “Below” refers to the area extending from the cart 104 toward the track 102 (i.e., in the −Y direction of the coordinate axes of FIG. 3).

In some embodiments, the track 102 may include two conductive rails (e.g. 111a and 111b). The conductive rails 111a, 111b may be coupled to an electrical power source 140 (FIG. 3). The electrical power source 140 (FIG. 3) may be an alternating current power source. For example, each one of the two parallel conductive rails 111a and 111b of the track 102 may be electrically coupled to one of the two poles (e.g., a negative pole and a positive pole) of the alternating current power source. In some embodiments, one of the parallel conductive rails (e.g., 111a) supports a first pair of wheels 222 (e.g., 222a and 222b) and the other one of the parallel conductive rails (e.g., 111b) supports a second pair of wheels (e.g., 222c and 222d). As such, at least one wheel 222 from each pair of wheels (e.g., 222a and 222c or 222b and 222d) are in electrical contact with each of the parallel conductive rails 111a and 111b so that the cart 104 and the components therein may receive electrical power and communication signals transmitted over the track 102.

Turning to the portion of FIG. 3 that includes first cart 104a, the portion of the track 102 that supports the wheels 222 of first cart 104a is segmented into two portions of track 102. That is, track 102 is segmented into a first electrically conductive portion 102′ and a second electrically conductive portion 102″. In some embodiments, the track 102 may be segmented into more than one electrical circuit. The electrically conductive portion of the track 102 may be segmented by a non-conductive section 101 such that a first electrically conductive portion 102′ of the track 102 is electrically isolated from a second electrically conductive portion 102″ of the track 102. For example, wheels 222a and 222c of first cart 104a are supported and electrically coupled to the first electrically conductive portion 102′ of the track 102 and wheels 222b and 222d of first cart 104a are supported and electrically coupled to the second electrically conductive portion 102″. The configuration allows the first cart 104a to continuously receive electrical power since at least two wheels (e.g., 222a and 222c or 222b and 222d) remain electrically coupled to one of the two electrically conductive portions of the track 102 as first cart 104a traverses the track 102.

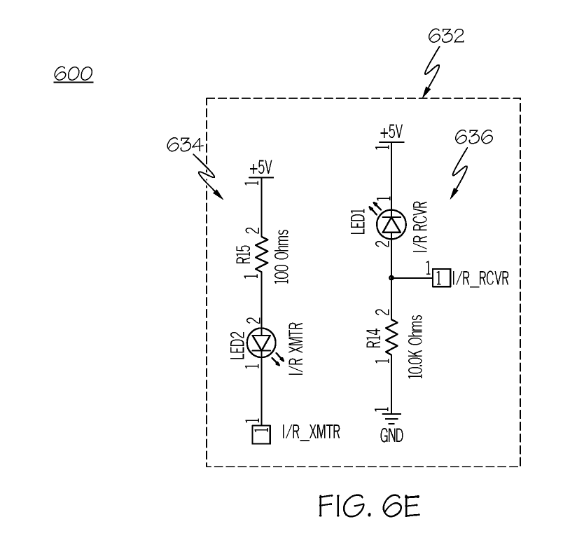

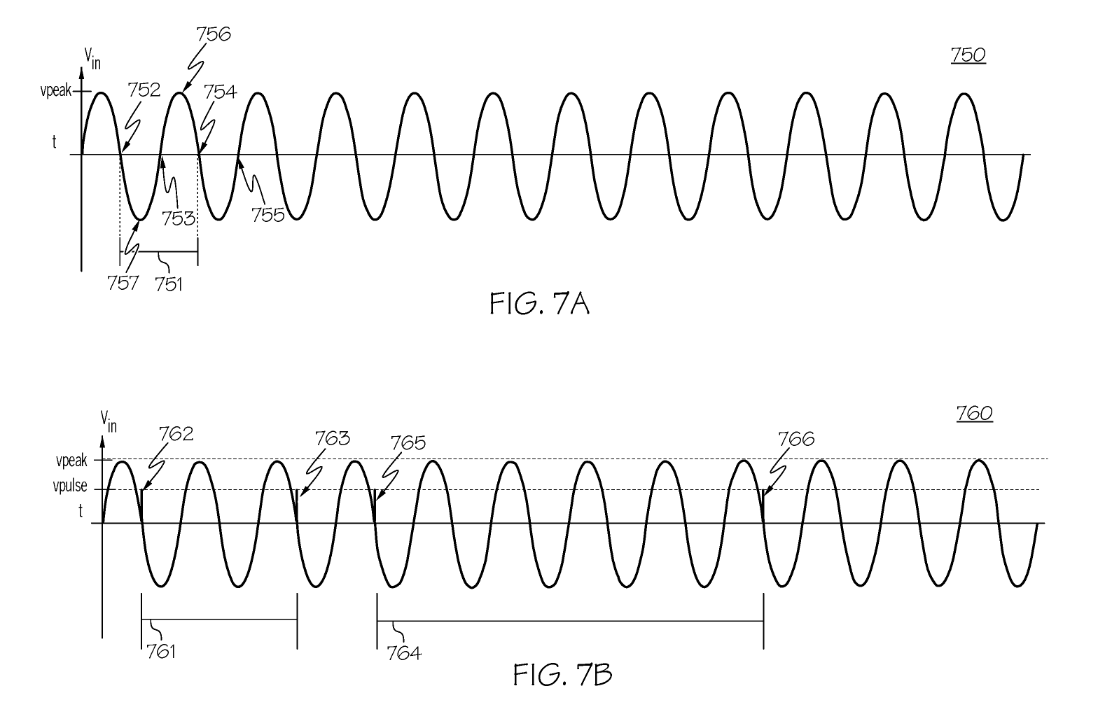

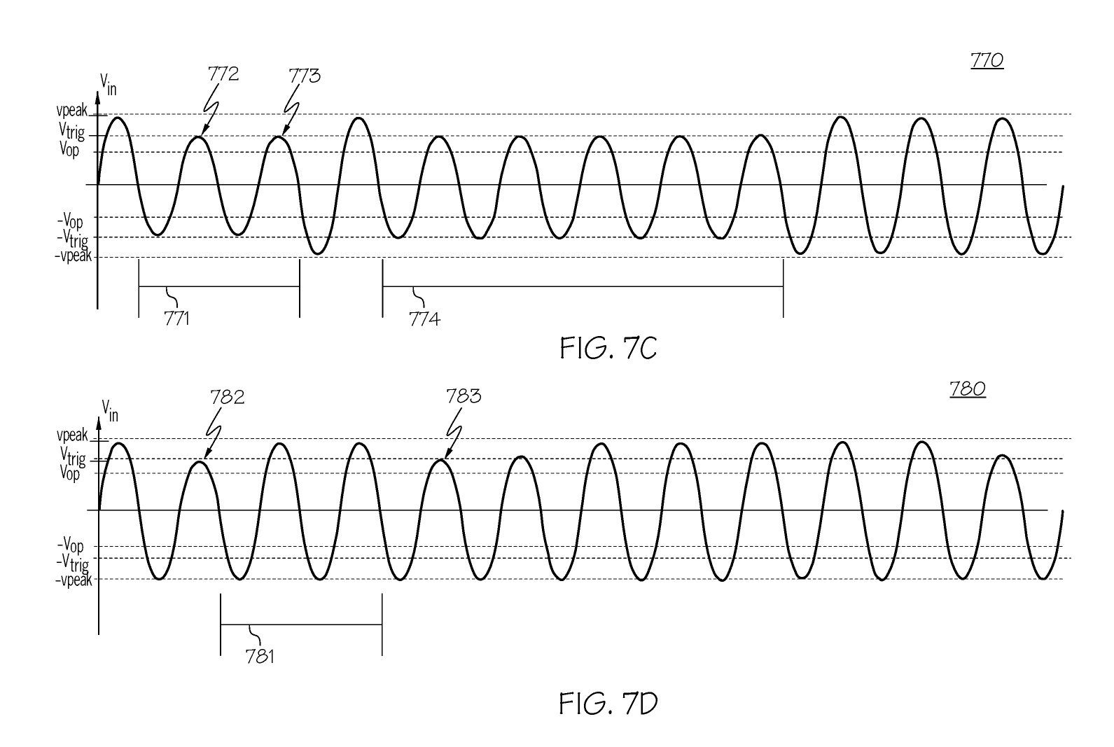

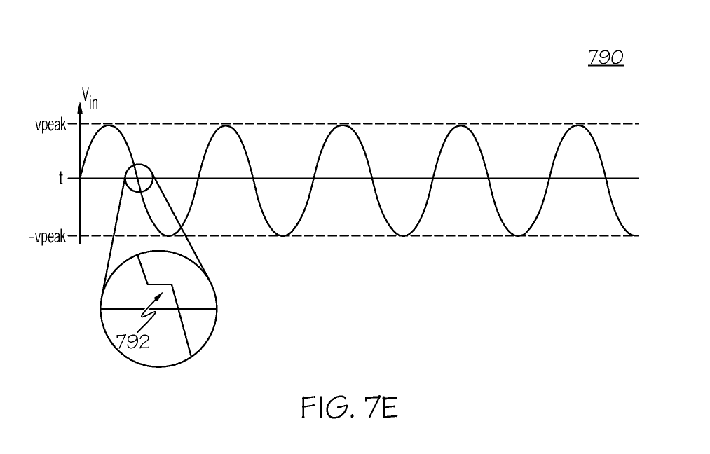

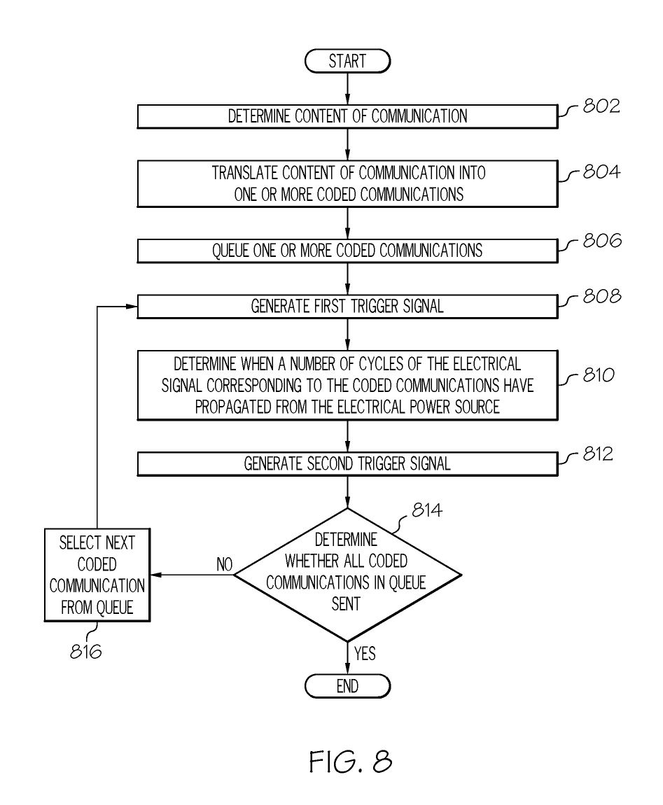

As the first cart 104a traverses the track 102 from the first electrically conductive portion 102′ to the second electrically conductive portion 102″, the cart-computing device 228 may select which of the pair of wheels (e.g., 222a and 222c or 222b and 222d) from which to receive electrical power and communication signals. In some embodiments, an electrical circuit may be implemented to automatically and continuously select and provide electrical power to the components of the first cart 104a as the first cart 104a traverses from the first electrically conductive portion 102′ to the second electrically conductive portion 102″ of the track 102. An example of such an electrical circuit is depicted in FIG. 7B which is described in more detail herein. The first cart 104a may be configured to select electrical power from either a first electrical signal transmitted to the first electrically conductive portion 102′ from a first electrical power source 140a or a second electrical signal transmitted to the second electrically conductive portion 102″ from a second electrical power source 140b when the cart 104 spans and traverses the track 102 from the first electrically conductive portion 102′ to the second conductive portion 102″.

For example, when wheels 222a and 222c are in electrical contact with the first electrically conductive portion 102′ and wheels 222b and 222d are in electrical contact with the second electrically conductive portion 102″, the cart-computing device 228 or an electric circuit may select which of the two conductive portions 102′ or 102″ to draw electrical power. Furthermore, the cart-computing device 228 or the electric circuit may prevent the two conductive portions 102′ or 102″ from being shorted as the first cart 104a traverses both segments and may prevent the first cart 104a from being overloaded by two electrical power sources. Therefore, the cart-computing device 228 or other communicatively coupled electronic circuit (e.g., as depicted in FIG. 7B) may receive electrical power from one of the two conductive portions 102′ or 102″ through the one or more wheels 222 and then distribute the electrical signal for use by the drive motor 226, the cart-computing device 228 and/or other electronic devices communicatively coupled to the cart 104.

Still referring to FIG. 3, the carts 104a-104c may include a back-up power supply 224a-224c, a drive motor 226a-226c, a cart-computing device 228a-228c, a tray 220 and/or the payload 230. Collectively, the back-up power supplies 224a-224c, drive motors 226a-226c, and cart-computing devices 228a-228c are referred to as back-up power supply 224, drive motor 226, and cart-computing device 228. The tray 220 may support a payload 230 thereon. Depending on the particular embodiment, the payload 230 may contain plants, seedlings, seeds, etc. However, this is not a requirement as any payload 230 may be carried on the tray 220 of the cart 104.

The back-up power supply 224 may include a battery, storage capacitor, fuel cell or other source of reserve electrical power. The back-up power supply 224 may be activated in the event the electrical power to the cart 104 via the wheels 222 and the track 102 is terminated. The back-up power supply 224 may be utilized to power the drive motor 226 and/or other electronics of the cart 104 in the event of a termination of electrical power via the wheels 222 and the track 102. For example, the back-up power supply 224 may provide electrical power to the cart-computing device 228 or one or more sensor modules (e.g., 232, 234, 236). The back-up power supply 224 may be recharged or maintained while the cart 104 is connected to the track 102 and receiving electrical power from the track 102.

The drive motor 226 is coupled to the cart 104. In some embodiments, the drive motor 226 may be coupled to at least one of the one or more wheels 222 such that the cart 104 is capable of being propelled along the track 102 in response to a received signal. In other embodiments, the drive motor 226 may be coupled to the track 102. For example, the drive motor 226 may be rotatably coupled to the track 102 through one or more gears, which engage a plurality of teeth, arranged along the track 102 such that the cart 104 is propelled along the track 102. That is, the gears and the track 102 may act as a rack and pinion system that is driven by the drive motor 226 to propel the cart 104 along the track 102.

The drive motor 226 may be configured as an electric motor and/or any device capable of propelling the cart 104 along the track 102. For example, the drive motor 226 may be a stepper motor, an alternating current (AC) or direct current (DC) brushless motor, a DC brushed motor, or the like. In some embodiments, the drive motor 226 may comprise electronic circuitry, which may be used to adjust the operation of the drive motor 226, in response to a communication signal (e.g., a command or control signal for controlling the operation of the cart 104) transmitted to and received by the drive motor 226. The drive motor 226 may be coupled to the tray 220 of the cart 104 or may be directly coupled to the cart 104. In some embodiments, more than one drive motor 226 may be included on the cart 104. For example, each wheel 222 may be rotatably coupled to a drive motor 226 such that the drive motor 226 drives rotational movement of the wheels 222. In other embodiments, the drive motor 226 may be coupled through gears and/or belts to an axle, which is rotatably coupled to one or more wheels 222 such that the drive motor 226 drives rotational movement of the axle that rotates the one or more wheels 222.

In some embodiments, the drive motor 226 is electrically coupled to the cart-computing device 228. The cart-computing device 228 may electrically monitor and control the speed, direction, torque, shaft rotation angle, or the like, either directly and/or via a sensor that monitors operation of the drive motor 226. In some embodiments, the cart-computing device 228 may electrically control the operation of the drive motor 226. The cart-computing device 228 may receive a communication signal transmitted through the electrically conductive track 102 and the one or more wheels 222 from the master controller 106 or other computing device communicatively coupled to the track 102. The cart-computing device 228 may directly control the drive motor 226 in response to signals received through a network interface hardware 414 (as depicted and described with reference to FIG. 4). In some embodiments, the cart-computing device 228 executes power logic 436 (as depicted and described with reference to FIG. 4) to control the operation of the drive motor 226.

Still referring to FIG. 3, the cart-computing device 228 may control the drive motor 226 in response to one or more signals received from one of the sensor modules (e.g., 232, 234, 236) included on the cart 104 in some embodiments. The sensor modules (e.g., 232, 234, 236) may include an infrared sensor, a photo-eye sensor, a visual light sensor, an ultrasonic sensor, a pressure sensor, a proximity sensor, a motion sensor, a contact sensor, an image sensor, an inductive sensor (e.g., a magnetometer) or other type of sensor capable of detecting at least the presence of an object (e.g., another cart 104 or a track sensor module 324) and generating one or more signals indicative of the detected event (e.g., the presence of the object).

In some embodiments, the communication signal may include operating information, status information, sensor data, and/or other analytical information about the cart 104 and/or the payload 230 (e.g., the plants growing therein) or instructions for controlling one or more other carts 104. For example, the operating information may include the speed, direction, torque, or etc. of the cart 104. Status information may include plant growth status, watering status, nutrient status, pH status or other information related to the plants growing therein. Status information may also include information about the cart 104, for example, the status of a backup battery, whether the drive motor 226 is operating within specified parameters, whether the cart 104 is receiving sufficient power from the track 102, or other related information. The communication signal may also relay sensor data obtained by the sensor module (e.g., 232, 234, 236). For example, a distance determined by a first sensor module (e.g., a leading sensor 232b of a middle cart 104b) may be relayed to a second sensor module (e.g., a trailing sensor 234c of a trailing cart 104c). In some embodiments, the first communication signal or the second communication signal may correspond to a malfunction of a cart 104.

In some embodiments, a sensor module (e.g., 232, 234, 236) may detect an event and transmit one or more signals in response to the detected event. As used herein, a “detected event” refers to an event for which a sensor module (e.g., 232, 234, 236) is configured to detect. For example, the sensor module (e.g., 232, 234, 236) may be configured to generate one or more signals that correspond to a distance from the sensor module (e.g., 232, 234, 236) to a detected object as a distance value, which may constitute a detected event. As another example, a detected event may be a detection of infrared light. In some embodiments, the infrared light may be generated by the infrared sensor reflected off an object in the field of view of the infrared sensor and received by the infrared sensor.

In response to receiving the one or more signals, the cart-computing device 228 may execute a function defined in an operating logic 432, communication logic 434 and/or power logic 436, which are described in more detail herein with reference to at least FIG. 4. For example, in response to the one or more signals received by the cart-computing device 228, the cart-computing device 228 may adjust, either directly or through intermediate circuitry, a speed, a direction, a torque, a shaft rotation angle, and/or the like of the drive motor 226.

In some embodiments, the sensor modules (e.g., 232, 234, 236) may be communicatively coupled to the master controller 106 (FIG. 1). The sensor modules (e.g., 232, 234, 236) may generate one or more signals that may be transmitted via the one or more wheels 222 and the track 102 (FIG. 1). The track 102 and/or the cart 104 may be communicatively coupled to a network 250 (FIG. 2). Therefore, the one or more signals may be transmitted to the master controller 106 via the network 250 over the network interface hardware 414 (FIG. 4) or the track 102 and in response, the master controller 106 may return a control signal to the cart 104 for controlling the operation of one or more drive motors 226 of one or more carts 104 positioned on the track 102.

While still referring to FIG. 3, a first signal generating circuit 142a and a second signal generating circuit 142b (collectively a signal generating circuit 142) may each be electrically and communicatively coupled in line with a first electrical power source 140a and a second electrical power source 140b, respectively, (collectively referred to herein as an electrical power source 140), to generate communication signals within the electrical signals provided to the track 102. For example, the first electrical power source 140a may be electrically coupled to a first signal generating circuit 142a, which is subsequently coupled to a first conductive portion 102′ of the track 102. In some embodiments, each conductive portion of the track 102 may include a separate electrical power source 140 and a separate signal generating circuit 142. For example, the second conductive portion 102″ may receive communication signals and electrical signals from the second signal generating circuit 142b and the second electrical power source 140b.

The electrical power source 140 may be any device capable of generating and/or providing an electrical signal as an output. In an alternating current (AC) power system, the electrical signal output by the electrical power source 140 may include a waveform. As discussed in more detail below with reference to FIGS. 7A-7D, the electrical signal may have a waveform in the form of a sine wave, a square wave, a triangle wave, or a sawtooth wave, which includes a plurality of zero-crossings as the voltage of the electrical signal oscillates from positive to negative. The characteristics (e.g., the zero-crossings and/or the oscillations) of the output waveform may be utilized by the signal generating circuit 142 to embed a communication signal within the electrical signal.

In some embodiments, the electrical power source 140 may be a transformer, which receives electrical energy as an input and converts the electrical energy to a voltage, current, and/or power level to power the carts 104 and other components electrically coupled to the track 102. For example, the electrical power source 140 may receive a 120-volt line voltage and convert the voltage to an 18-volt electrical signal. In some embodiments, the transformer may include one or more taps for selectively adjusting the output voltage of the transformer. For example, one tap may output an 18-volt electrical signal and another tap may cause the transformer to output a 14-volt electrical signal.

The signal generating circuit 142 may be any arrangement of components capable of introducing a communication signal within the electrical signal from the electrical power source 140. In some embodiments, the signal generating circuit 142 may be an electrical circuit coupled in line with the electrical power source 140. As described in more detail herein, the signal generating circuit 142 may introduce a pulse (e.g., a voltage pulse) during a zero-crossing of the electrical signal or adjust the peak voltage level of the electrical signal to embed a communication signal within the electrical signal. For example, the signal generating circuit 142 may include an operational amplifier configured to track and/or count the oscillations and/or the zero-crossings of the electrical signal. The signal generating circuit 142 may deliver a pulse of voltage into the electrical signal during select zero-crossings of the electrical signal. In some embodiments, the signal generating circuit 142 may include a processor 144 and non-transitory computer-readable memory 146. For example, as depicted in FIG. 3, the first signal generating circuit 142a may include a processor 144a and a non-transitory computer-readable memory 146a and the second signal generating circuit 142b may include a processor 144b and a non-transitory computer-readable memory 146b. The processor 144 may execute commands stored within the non-transitory computer-readable memory 146 when a zero-crossing event is detected by the signal generating circuit 142. The processor 144 and the non-transitory computer-readable memory 146 of the signal generating circuit 142 may be similar device as to the processor 410 and memory component 430 of the cart 104, described with reference to FIG. 4 herein.

In some embodiments, the master controller 106 may be communicatively coupled to the electrical power source 140 and/or the signal generating circuit 142. The master controller 106 may control the operation of the electrical power source 140. For example, the master controller 106 may provide control signals for powering on or off the electrical power source 140. The master controller 106 may also provide control signals for selecting different transformer taps, thereby adjusting the peak output voltage of the electrical power source 140. In some embodiments, the master controller 106 may be communicatively coupled to the signal generating circuit 142. As such, the master controller 106 may provide the signal generating circuit 142 with content for a communication signal and the signal generating circuit 142 may encode the content in one or more coded communications to transmit with the electrical signal. In some embodiments, the master controller 106 may operate as the signal generating circuit 142. That is, the master controller 106 may control the operation of the electrical power source 140 to affect a communication signal within the electrical signal, for example, by adjusting the peak voltage level of the electrical signal.

Referring to FIG. 4, a cart-computing device 228 is depicted. As illustrated, the cart-computing device 228 includes a processor 410, input/output hardware 412, the network interface hardware 414, a data storage component 416 (which stores systems data 418, plant data 420, and/or other data), and the memory component 430. The memory component 430 may store operating logic 432, the communications logic 434, and the power logic 436. The communications logic 434 and the power logic 436 may each include a plurality of different pieces of logic, each of which may be embodied as a computer program, firmware, and/or hardware, as an example. A local communications interface 440 is also included in FIG. 4 and may be implemented as a bus or other communication interface to facilitate communication among the components of the cart-computing device 228.

The processor 410 may include any processing component operable to receive and execute instructions (such as from a data storage component 416 and/or the memory component 430). The processor 410 may be any device capable of executing the machine-readable instruction set stored in the memory component 430. Accordingly, the processor 410 may be an electric controller, an integrated circuit, a microchip, a computer, or any other computing device. The processor 410 is communicatively coupled to the other components of the assembly line grow pod 100 by a communication path and/or the local communications interface 440. Accordingly, the communication path and/or the local communications interface 440 may communicatively couple any number of processors 410 with one another, and allow the components coupled to the communication path and/or the local communications interface 440 to operate in a distributed computing environment. Specifically, each of the components may operate as a node that may send and/or receive data. While the embodiment depicted in FIG. 4 includes a single processor 410, other embodiments may include more than one processor 410.

The network interface hardware 414 is coupled to the local communications interface 440 and communicatively coupled to the processor 410, the memory component 430, the input/output hardware 412, and/or the data storage component 416. The network interface hardware 414 may be any device capable of transmitting and/or receiving data via a network 250 (FIG. 2). Accordingly, the network interface hardware 414 can include a communication transceiver for sending and/or receiving any wired or wireless communication. For example, the network interface hardware 414 may include and/or be configured for communicating with any wired or wireless networking hardware, including an antenna, a modem, LAN port, Wi-Fi card, WiMax card, ZigBee card, Bluetooth chip, USB card, mobile communications hardware, near-field communication hardware, satellite communication hardware and/or any wired or wireless hardware for communicating with other networks and/or devices. In some embodiments, the network interface hardware 414 may be utilized to transmit signals to and from the signal generating circuit 142, which are then provided and/or received from the wheels 222 of the cart 104 and the track 102.

In one embodiment, the network interface hardware 414 includes hardware configured to operate in accordance with the Bluetooth wireless communication protocol. In another embodiment, the network interface hardware 414 may include a Bluetooth send/receive module for sending and receiving Bluetooth communications to/from the network 250 (FIG. 2). The network interface hardware 414 may also include a radio frequency identification (“RFID”) reader configured to interrogate and read RFID tags. From this connection, communication may be facilitated between the cart-computing devices 228 of the carts 104, the master controller 106 and/or the remote computing device 252 depicted in FIG. 2.

The memory component 430 may be configured as volatile and/or nonvolatile memory and may comprise RAM (e.g., including SRAM, DRAM, and/or other types of RAM), ROM, flash memories, hard drives, secure digital (SD) memory, registers, compact discs (CD), digital versatile discs (DVD), or any non-transitory memory device capable of storing machine-readable instructions such that the machine-readable instructions can be accessed and executed by the processor 410. Depending on the particular embodiment, these non-transitory computer-readable mediums may reside within the cart-computing device 228 and/or external to the cart-computing device 228. The machine-readable instruction set may comprise logic or algorithm(s) written in any programming language of any generation (e.g., 1GL, 2GL, 3GL, 4GL, or 5GL) such as, for example, machine language that may be directly executed by the processor 410, or assembly language, object-oriented programming (OOP), scripting languages, microcode, etc., that may be compiled or assembled into machine readable instructions and stored in the non-transitory computer readable memory, e.g., the memory component 430. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 4 includes a single non-transitory computer readable memory, e.g. memory component 430, other embodiments may include more than one memory module.

Still referring to FIG. 4, the operating logic 432 may include an operating system and/or other software for managing components of the cart-computing device 228. As also discussed above, the communications logic 434 and the power logic 436 may reside in the memory component 430 and may be configured to perform the functionality, as described herein.

In some embodiments, the cart 104 may include a signal generating circuit 142 which may be included as part of the cart-computing device 228. For example, the input/output hardware 412 may include circuitry, which implements the signal generating circuit 142. In such an embodiment, the signal generating circuit 142 may generate a communication signal within the alternating current electrical signal propagating along the track 102 in a similar fashion to that of the signal generating circuit 142 electrically coupled to the electrical power source 140.

It should be understood that while the components in FIG. 4 are illustrated as residing within the cart-computing device 228, this is merely an example. In some embodiments, one or more of the components may reside on the cart 104 external to the cart-computing device 228. It should also be understood that, while the cart-computing device 228 is illustrated as a single device, this is also merely an example. In some embodiments, the communications logic 434 and the power logic 436 may reside on different computing devices. As an example, one or more of the functionalities and/or components described herein may be provided by the master controller 106 and/or the remote computing device 252.

Additionally, while the cart-computing device 228 is illustrated with the communications logic 434 and the power logic 436 as separate logical components, this is also an example. In some embodiments, a single piece of logic (and/or or several linked modules) may cause the cart-computing device 228 to provide the described functionality.

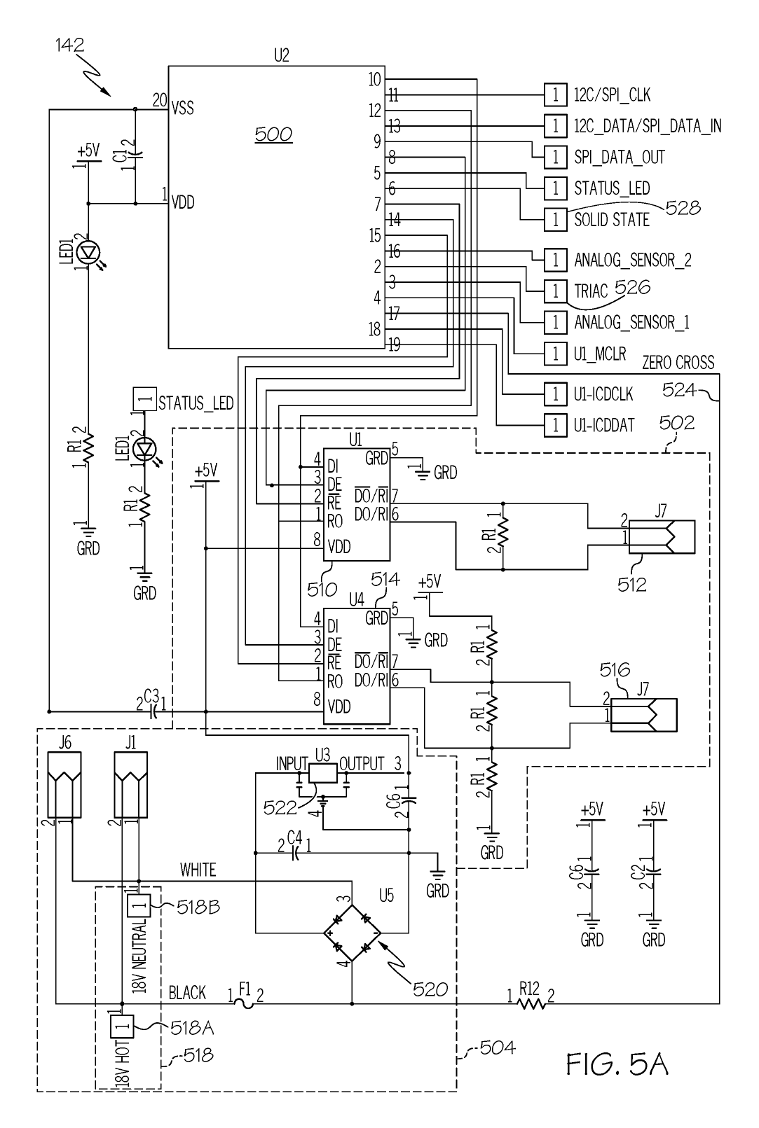

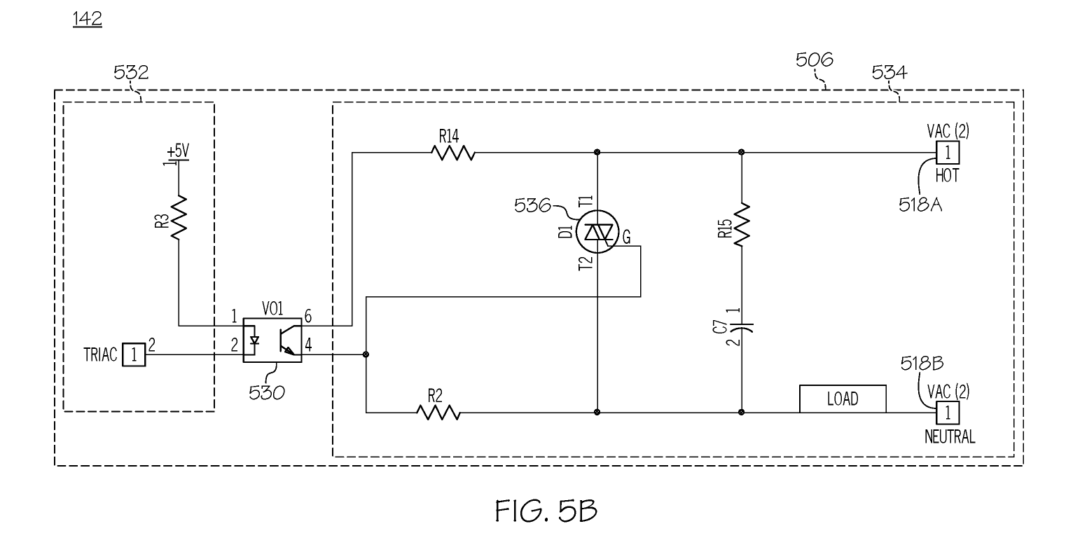

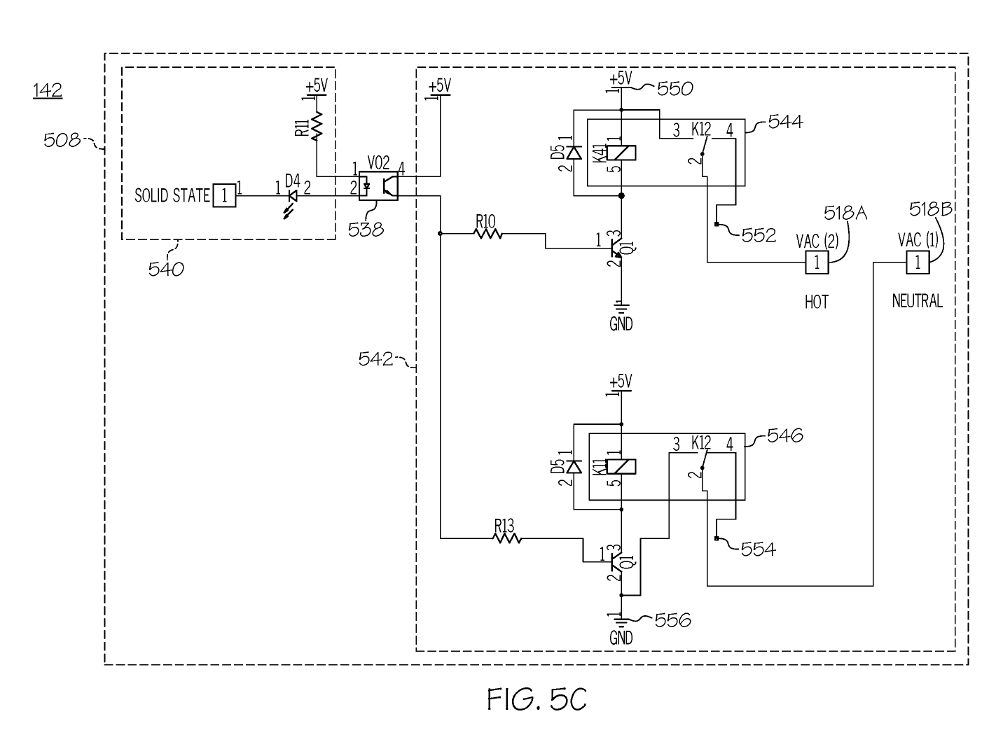

Referring to FIGS. 5A-5C, a schematic of the signal generating circuit 142 is depicted. The schematic depicted in FIGS. 5A-5C is only an example of many circuits, which may implement the functionality of the signal generating circuit 142 as described herein. FIGS. 5A-5C provide an example implementation of a signal generating circuit 142, which is capable of introducing a communication signal within the electrical signal from the electrical power source 140 (FIG. 3). In some embodiments, the signal generating circuit 142 may include a microcontroller 500, a transceiver circuit 502, a power supply 504, and one or more communication signal driver circuits 506 and 508 (e.g., shown in FIGS. 5B and 5C). The microcontroller 500 may be any processing component operable to receive and execute instructions. The microcontroller 500 may execute machine-readable instructions stored in the memory of the component or received from another processing device. The microcontroller 500 may be an electric controller, an integrated circuit, a microchip, a computer, or any other computing device. The microcontroller 500 is communicatively coupled to the other components of the signal generating circuit 142 and optionally other components of the assembly line grow pod 100 by a communication path and/or the local communications interface.

The signal generating circuit 142 may further include a transceiver circuit 502 that may be coupled to the master controller 106 or other computing device through ports 512 and/or 516. The master controller 106 or other computing device may transmit commands via a signal to one or more transceiver components 510 and 514 of the transceiver circuit 502. The transceiver circuit 502 provides communication to and from the microcontroller 500 with the master controller 106, the carts 104 via the track 102, and/or other computing devices. In some embodiments, the transceiver circuit 502 may be included in the microcontroller 500. Therefore, the external transceiver components, for example, transceiver components 510 and 514 may not be required.

Additionally, the signal generating circuit 142, as described above, may be coupled to the electrical power source 140 and may further include a power supply 504. The power supply 504 may receive an alternating current electrical signal from the electrical power source 140 through connection ports 518 and convert the alternating current electrical signal into a rectified power signal using a rectifier 520. The rectifier 520 may further be coupled to a voltage regulator 522 that regulates the rectified voltage to a predetermined voltage level for powering the microcontroller 500, generating one or more communication signals or trigger signals, and/or other components of the signal generating circuit 142.

In some embodiments, the signal generating circuit 142 may be capable of detecting a zero-crossing event, calculating when another zero-crossing event will occur, and introducing a communication signal. To detect a zero-crossing of the alternating current electrical signal from the electrical power source 140, the microcontroller 500 may include an AC-to-DC input 524, which is coupled to either the HOT branch 518A or the NEUTRAL branch 518B of the electrical power source 140. The microcontroller 500 may be configured, for example, through logic stored therein, to detect the zero-crossing of the alternating current electrical signal as sensed at the AC-to-DC input 524. In response to sensing the zero-crossing, the microcontroller 500 may selectively change the state of the TRIAC signal pin 526 and/or the solid state signal pin 528 based on the communication signal to be generated.

As described and depicted in more detail with respect to FIGS. 7A-7E, the communication signal may be provided in a plurality of different manners. For example the communication signal may be a voltage pulse during a zero-crossing, a delay in the AC waveform of the alternating current electrical signal, a reduction in the peak voltage of the alternating current electrical signal, or the like. The portions of the schematic of the signal generating circuit 142 depicted in FIGS. 5B-5C provide two example communication signal driver circuits 506 and 508. The first is a TRIAC circuit 506, depicted in FIG. 5B, which generates a communication signal by introducing a delay in the waveform of the alternating current electrical signal. The second is a solid state circuit 508, depicted in FIG. 5C, which generates a communication signal by introducing a DC voltage pulse during a zero-crossing of the alternating current electrical signal.

Referring to FIG. 5B, the schematic for a TRIAC circuit 506 of a signal generating circuit 142 is depicted. The TRIAC circuit 506 includes an optoisolator component 530 coupled to the TRIAC signal pin 526 of the microcontroller 500. An optoisolator component 530 is a device that uses a short optical transmission path to transfer electrical signals between circuits or elements of a circuit, while keeping them electrically isolated from each other. For example, an optoisolator may include a light-emitting diode capable of emitting light and a photoreceptor or photodiode to receive light from the light-emitting diode. Activation of the light-emitting diode by the first circuit 532 may cause the second circuit 534 to be communicatively coupled to the first circuit 532 through the transmission of light. As such, signals may be transmitted between the circuits 532 and 534 while keeping the circuits electrically isolated. In the absence of light, the two circuits 532 and 534 remain electrically and communicatively isolated. While the TRIAC circuit 506 depicts the implementation of an optoisolator component 530, other components, which achieve the same goal of controlling a second circuit 534 with a first circuit 532, may be utilized.

As depicted in FIG. 5B, the second circuit 534 of the TRIAC circuit 506 includes a TRIAC component 536 coupled to the HOT branch 518A and the NEUTRAL branch 518B of the electrical power source 140 and the gate of the TRIAC component 536 is coupled to the optoisolator component 530. The TRIAC component 536 is a three terminal component, which is capable of conducting current in opposing directions when activated, and blocking the flow of current when deactivated. As depicted in the TRIAC circuit 506 of FIG. 5B, the TRIAC component 536 operates to introduce a delay in the alternating current electrical signal, which is depicted and described in more detail with respect to FIG. 7E.

Referring to FIG. 5C, the schematic for a solid state circuit 508 of a signal generating circuit 142 is depicted. The solid state circuit 508 includes an optoisolator component 538 coupled to a first circuit 540 and a second circuit 542. The first circuit includes a 5-volt source 550 and communication with the solid state signal pin 528 of the microcontroller 500. The second circuit 542 includes a first relay 544 and a second relay 546, a 5-volt source 550 and connection to the HOT branch 518A and the NEUTRAL branch 518B of the electrical power source 140. When the optoisolator component 538 is activated, the first relay 544 switches from an open connection 552 with the HOT branch 518A of the electrical power source 140 to a 5-volt source 550. Similarly, when the optoisolator component 538 is activated, the second relay 546 switches from an open connection 554 with the NEUTRAL branch 518B of the electrical power source 140 to a ground connection 556 thereby completing a circuit with the 5-volt source 550 and generating a DC voltage pulse within the alternating current electrical signal from the electrical power source 140. The functionality of generating the DC voltage pulse within the alternating current electrical signal is further depicted and described with respect to FIG. 7B.

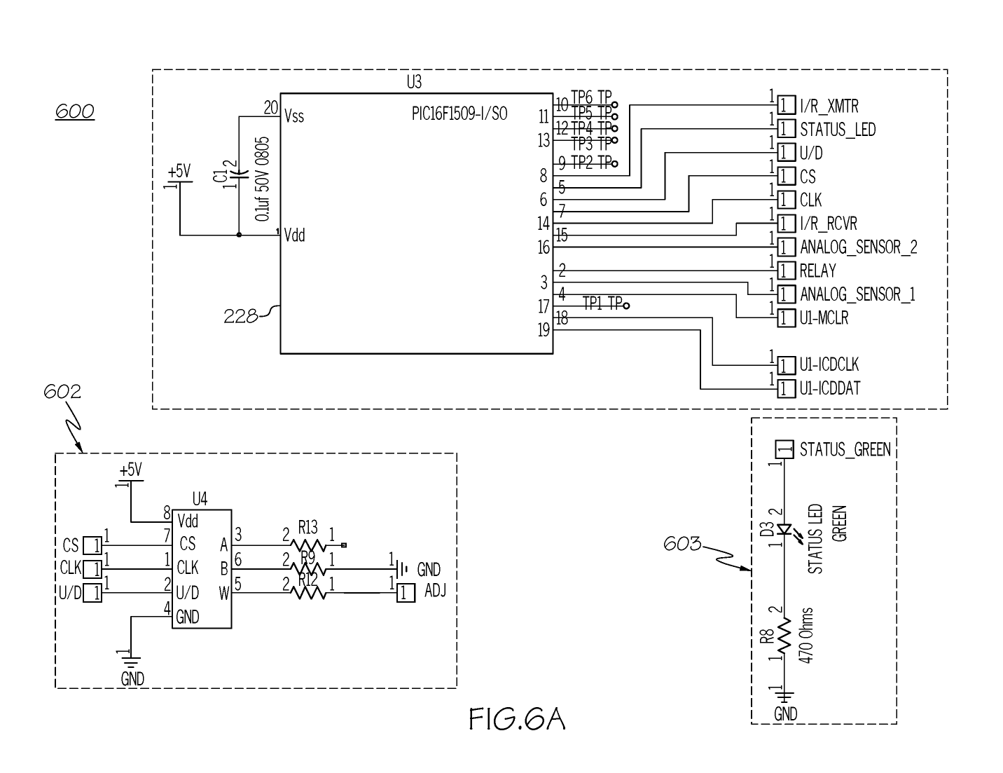

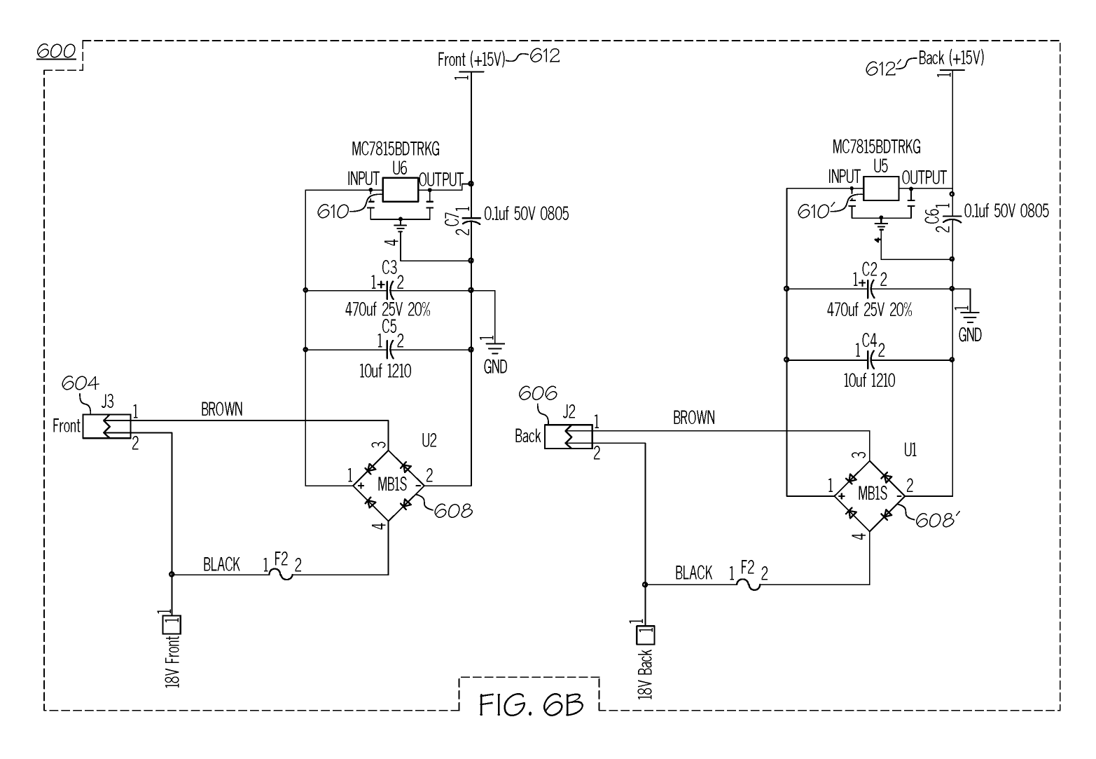

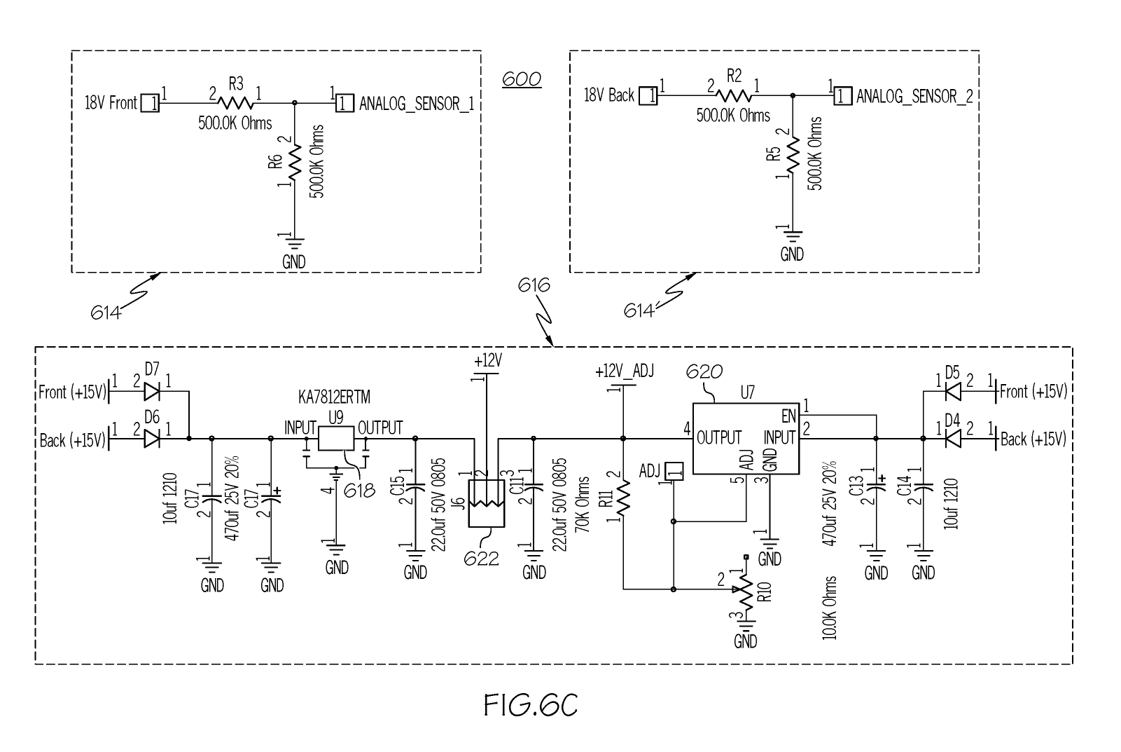

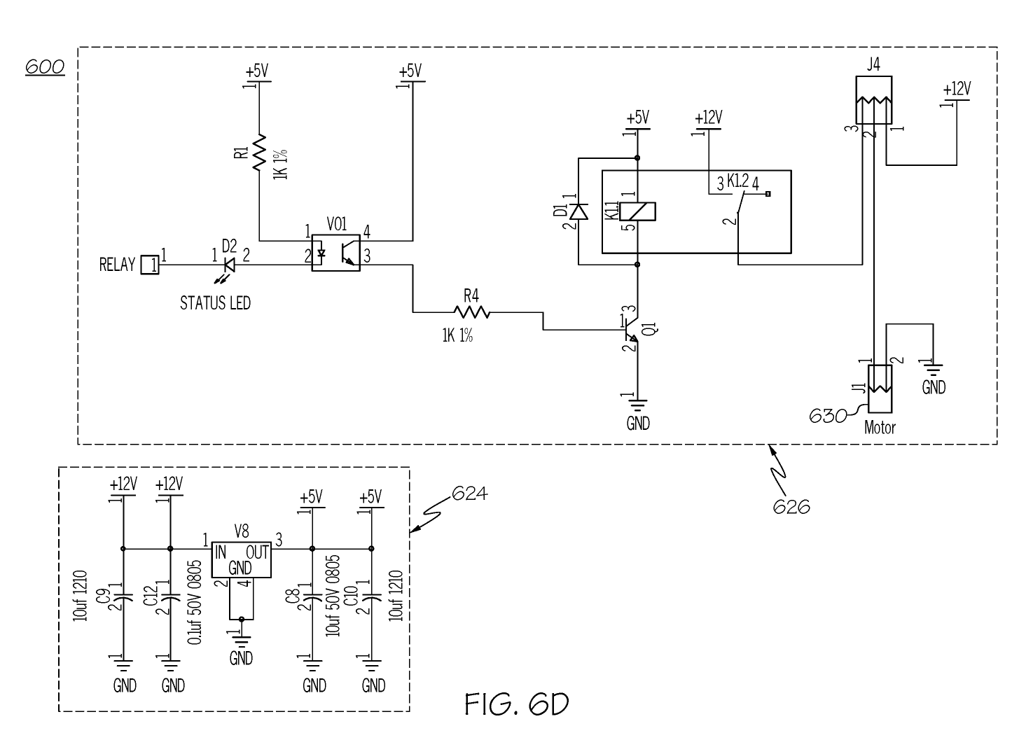

Referring now to FIGS. 6A-6E, a circuit diagram 600, which is an example circuit for implementing the electronics of the cart 104 (FIG. 1), is depicted. As depicted in FIG. 6A, the electronics of the cart 104 may be controlled through a cart-computing device 228, for example, the cart-computing device 228 may be a microcontroller also referred to as a peripheral interface controller (“PIC”) 228. The PIC microcontroller 228 may include ROM, flash memory, or other forms of non-transitory computer readable memory for storing machine-readable instruction sets such as operating logic 432, communication logic 434, and power logic 436. The memory component 430 may also store data such as cart data or plant data 420. The PIC microcontroller 228 may also include processing capabilities and more than one input and output interface for communicatively coupling with input/output hardware 412, network interface hardware 414, one or more sensor modules (e.g., 232, 234, 236) or other components associated with the cart 104. Furthermore, some PIC microcontrollers 228 include an internal clock and some utilize an external clock signal as an input. As depicted, the PIC microcontroller 228 receives a clock signal input from an external clock-generating component depicted in sub-circuit 602. Generally, a clock signal is produced by a clock generator and is used by the PIC microcontroller 228 to synchronize different components of a circuit and the execution of instructions at specified intervals and rates (i.e., frequencies). Additionally, the PIC microcontroller 228 couples through one of the input and output interfaces to a status sub-circuit 603. The status sub-circuit 603 includes a status LED that may be used to indicate a status, such as power or operating state of the PIC microcontroller 228.

As discussed in detail above, the cart 104 receives electrical power and communication signals via the wheels 222, which are in contact with the track 102 as described herein. The circuit diagram 700 is continued in FIG. 6B, which depicts a sub-circuit where the pair of front wheels (for example, a pair of wheels 222a and 222c, FIG. 3 electrically coupled to opposite conductive rails of the track 102), is electrically connected to the circuit at junction 604. Similarly, the pair of back wheels (e.g., 222b and 222d, FIG. 3) is electrically connected to the circuit at junction 606. Each wheel 222 in the pair of front wheels (e.g., 222a and 222c, FIG. 3) connects, for example, through wires, to a diode bridge 608 and subsequently to a voltage regulator 610. As such, the sub-circuit converts the AC power signal to a DC power signal and regulating the DC power signal to an output voltage 612 at to a predefined level, for example, 15 volts. Similarly, the pair of back wheels (e.g., 222b and 222d, FIG. 3) is connected to a diode bridge 608′ and subsequently to a voltage regulator 610′ to generate an output voltage 612′.

As shown in FIG. 6C, the PIC microcontroller 228, through a voltage divider circuit 614 and 614′ and separate analog sense interfaces of the PIC microcontroller 228, is electrically coupled to one of the wheels 222 (e.g., the wires or electrical pick-up coupled to the wheel 222) of each of the pair of front wheels (e.g., 222a and 222c) and the pair of back wheels (e.g., 222b and 222d). In some embodiments, the analog sensor interface, which is communicatively coupled to the wheels 222 of the cart 104, may receive communication signals embedded with the electrical signals transmitted via the track 102 to the cart 104. The analog sensor interface may detect a first trigger signal and the second trigger signal. Additionally, the analog sensor interface may determine the number of cycles, which have propagated between detection of the first trigger signal and the second trigger signal. As such, the PIC microcontroller 228 may determine the coded communication corresponding to the number of cycles detected by the analog sensor interface.

Still referring to circuit diagram 600, FIG. 6C further depicts a sub-circuit 716 for converting the 15-volt output voltage 612 and 612′ (from FIG. 6B) to a 12-volt output voltage as depicted in sub-circuit 616. Sub-circuit 616 includes a 12-volt regulator 618 circuit and an adjustable 12-volt regulator circuit 620. In some embodiments, a 12-volt source from the 12-volt regulator 618 may be sufficient. In some embodiments, a more finely tuned 12-volt source may be required. Therefore, the 12-volt source may be drawn from the output of the adjustable 12-volt regulator circuit 620. In some embodiments, this may be accomplished by adjusting a jumper on a set of header pins, for example, at junction 622.

Still referring to circuit diagram 600, FIG. 6D further depicts a sub-circuit 616 Sub-circuit 624 depicts another voltage regulator circuit. Sub-circuit 624 converts the 12-volt source to a 5-volt source using a 5-volt voltage regulator. Each of the various voltage sources are utilized by various components of the circuit for the cart 104. Sub-circuit 626 depicts a motor control circuit. The motor control circuit is coupled with the PIC microcontroller 228 for controlling the operation of the motor, which is electrically coupled to junction 630. Sub-circuit 626 may receive a control signal from the PIC microcontroller 228 and through an optocoupler and other circuit components activate or deactivate the motor.

As further depicted in the circuit diagram 600 and depicted in FIG. 6E, the PIC microcontroller 228 may be communicatively coupled to a sensor module (e.g., 232, 234, 236). The sensor module (e.g., 232, 234, 236) may include an IR sensor circuit 632. The IR sensor circuit 632 includes an IR emitter circuit 634 and an IR detector circuit 636. As described herein, the IR detectors and emitters may be implemented to sense other carts 104 or track sensor modules 324 on the track 102. Additionally, IR detectors may be implemented to provide communication to and from the cart 104. Although circuit diagram 600 depicts only one IR sensor circuit 632 having an IR emitter circuit 634 and an IR detector circuit 636, in some embodiments, the cart 104 may include one or more IR senor circuits 632 or other type of sensor circuits. These sensor circuits may be implemented as the leading sensor 232, the trailing sensor 234, and/or the orthogonal sensor 236 as described herein.

Referring now to FIGS. 7A-7E, a plurality of voltage waveforms of electrical signals and/or communication signals within the electrical signals are depicted. In particular, FIG. 7A depicts an alternating current electrical signal 750 output from an electrical power source 140. As depicted, the alternating current electrical signal 750 is a sine wave. Alternating current electrical signal 750 includes a continuous chain of repeating oscillating cycles. For example, the interval of a wave from a first point along the curve to where the first point is repeated is a cycle 751. For example, a single cycle 751 is depicted as the interval from a first falling edge zero-crossing 752 to a second falling edge zero-crossing 754. A zero-crossing (e.g., 752, 753, 754, 755) refers to the point at which the voltage values transition from positive to negative values or vice versa. In other words, it is the point of inflection for the alternating current electrical signal. That is, the voltage values are temporarily a zero value. More particularly, a falling edge zero-crossing (e.g., 752 and 754) refers to a transition in voltage values from positive to negative. Conversely, a rising edge zero-crossing (e.g., 753 and 755) refers to a transition in voltage values from negative to positive. Another typical characteristic of an alternating current electrical signal 750 is that the peak voltage level (e.g., 756 and 757) (i.e., the positive peak voltage 756 and the negative peak voltage 757) occurs at about the same level from cycle to cycle. As such, a signal generating circuit 142 may exploit the repetitive nature of the alternating current electrical signal 750 to embed communication signals within, as now described with reference to FIGS. 7B-7E.

Referring to FIG. 7B, an alternating current electrical signal 760 with voltage pulses at select zero-crossings is depicted. Moreover, the waveform depicted in FIG. 7B depicts an example output of the alternating current electrical signal 760 transmitted from the signal generating circuit 142 to the track 102. In such embodiments, the communication signal 761 includes a first trigger signal 762 having a first voltage pulse during a first zero-crossing, one or more cycles of the alternating current electrical signal 760, and a second trigger signal 763 having a second voltage pulse during a subsequent zero-crossing. In some embodiments, the first and second trigger signal 762, 763 may be the presence of a pulse (e.g., a 5-volt pulse) introduced in the alternating current electrical signal 760 during the zero-crossing.

In some embodiments, the first trigger signal 762 may be a first voltage pulse, which indicates the beginning of a communication signal 761 and the second trigger signal 763 may be a second voltage pulse, which indicates the end of the communication signal 761. The number of cycles (e.g., two cycles are enclosed between the first and second trigger signal 762 and 763 of the communication signal 761) may correspond to the content of the communication signal 761. That is, the content of the communication signal 761 is a coded communication representing, for example, an instruction, data, an ID (e.g., an address) of an intended recipient, a control signal, status information, sensor data, or the like. For example, a two-cycle count (e.g., the first communication signal 761) may correspond to an instruction for powering on the drive motor 226 and an eight-cycle count (e.g., a second communication signal 764) may correspond to an instruction for powering off the driver motor. In some embodiments, a zero-cycle count may be established by transmitting a first trigger signal and a second trigger signal within a half-cycle, for example, at the falling edge zero-crossing 752 (FIG. 7A) and at the rising edge zero-crossing 753 (FIG. 7A). Furthermore, each of the coded communications may be predefined in the cart-computing devices 228 (FIG. 3) of the carts 104 (FIG. 3) and/or the master controller 106 (FIG. 3) so that the cart-computing device 228 (FIG. 3) and/or the master controller 106 (FIG. 3) may translate the number of cycles into the corresponding coded communication representing an instruction, data, an ID of an intended recipient, a control signal or the like.

In some embodiments, several communication signals may be transmitted in succession. For example, the second communication signal 764, as depicted in the waveform, may be initiated with a first trigger signal 765 followed by a number of cycles of the alternating current electrical signal 760 and concluded with a second trigger signal 766. In some embodiments, a first communication signal (e.g., 761) may include a coded communication corresponding to an instruction for all the carts 104 on the track 102 to activate their drive motors 226 and a second communication signal may correspond to the period of time for which to activate the drive motors 226 For example, when communicated in succession, the first communication signal 761 may instruct the cart 104 to power on the drive motor 226 and the second communication signal 764 may instruct the cart 104 to keep the power to the drive motor 226 on for a period of time. The period of time is not limited by this disclosure and may be any period of time. For example, the period of time may be eight seconds. As such, when executed by the cart 104 the drive motor 226 will be powered on for eight seconds and then powered off

In some embodiments, multiple communication signals may be compiled to form a set of instructions. For example, some communication signals may prompt a recipient to start a list of commands that will form a set of commands. That is, a first communication signal may correspond to an instruction to all carts 104 to start a new list of commands in memory. In response, the carts 104 may generate a new list in their non-transitory computer-readable memory to store the following set of coded communications provided by the series of communication signals. The next communication signal may include a coded communication to power on the drive motor 226. The next communication signal may include a coded communication indicating that the subsequent communication signal will indicate the duration in seconds for powering on the drive motor 226. In some embodiments, a communication signal may adjust how a subsequent communication signal is interpreted. For example, by providing a communication signal that indicates a subsequent signal will be a numerical value for duration, for example, the cart-computing device 228 and/or master controller 106 may treat the number of cycles present between the first trigger signal and the second trigger signal as an absolute number value rather than as a coded communication. Following the previous set of example communication signals the non-transitory computer-readable memory of the cart-computing device 228 and/or the master controller 106 may now include a set of instructions to power on the drive motor 226 for a duration of X seconds. To execute this set of instructions, another communication signal may be provided with a coded communication corresponding to the instruction to execute the set of instructions stored in the command list. In some embodiments, a communication signal may correspond to a coded communication that is executed as soon as it is received by a recipient, for example, a cart-computing device 228 and/or a master controller 106. In some embodiments, a communication signal may correspond to a coded communication to execute one or more coded communications at a predetermined time or after a specified delay.

In some embodiments, communication signals may be intended for all or only select carts 104. For example, a first communication signal may provide a coded communication indicating to the cart-computing device 228 of the carts 104 on the track 102 and/or the master controller 106 that the following communication signal(s) will indicate the intended recipients of further communication signals. In such embodiments, each cart 104 and/or master controller 106 may be assigned a unique address, for example, a numerical address that is subsequently indicated by the number of cycles between the first and second trigger signals.

Table 1 below provides some example coded communications that may be stored in the cart-computing device 228 of a cart 104 and/or the master controller 106. The list of coded communications may be used by the cart-computing device 228 of a cart 104 and/or the master controller 106 to translate the number of cycles in a communication signal to an instruction, data, an ID of an intended recipient, a control signal or the like.

TABLE 1

| Coded | |
|---|---|
| Communication | Instruction |
| 0 | Next signal for all carts (all carts receive |
| | subsequent communication signal) |
| 1 | Execute commands in list |
| 2 | Clear list of commands |
| 3 | New set of instructions to follow, create |
| | new list to store commands |
| 4 | Power on drive motor |
| 5 | Power off drive motor |
| 6 | Set delay to value |
| | (value, e.g., in seconds, is determined |
| | based on number of cycles in following |
| | communication signal) |
| 7 | Set drive motor direction to forward |
| 8 | Set drive motor direction to reverse |
| 9 | Power off |
| 10 | Next signal will indicate specific |
| | recipient followed by a coded |
| | communication(s) (the next signal will |
| | be treated as a numerical value rather |
| | than a coded communication) |

In a non-limiting example, the following series of numbers indicates an example series of communication signals (e.g., the predetermined number of cycles corresponding to a coded communication) transmitted by the signal generating circuit 142: 2, 3, 7, 4, 6, 20, 5, 8, 4, 6, 5, 5, 10, 10, 9, 0, 1.

The previous example series of individual communication signals will result in the following functionality. First, all the carts 104 (i.e., that are communicatively coupled to the signal generating circuit 142 generating the series of communication signals) will clear any list of coded communications stored in their non-transitory computer-readable memory in response the 2-cycle count. Next, all the carts 104 will create a new list to populate with a new set of coded communications in response to the 3-cycle count. Next, a command to set the drive motor 226 to the forward direction will be entered in the list in response to the 7-cycle count. Next, a command to power on the drive motor 226 is entered in the list in response to the 4-cycle count. Next, a command to delay is entered in the list in response to the 6-cycle count. Next, in response to the 20-cycle count the delay command is updated with a parameter of 20 seconds, making the delay a 20 second delay when it is executed. That is, when executing a delay, the execution of any commands stored in the list following the delay command will not be executed until the delay command has been completed. Next, a command to power off the drive motor 226 is entered in the list in response to the 5-cycle count. Next, a command to set the drive motor 226 to the reverse direction is entered in the list in response to the 8-cycle count. Next, a command to power on the drive motor 226 is entered in the list in response to the 4-cycle count. Next, a command to delay is entered in the list in response to the 6-cycle count. Again, the communication signal following the coded communication corresponding to a delay is a parameter for the delay command and is treated as a numerical value rather than a command. As such, the delay is set to 5 seconds in response to the 5-cycle count followed by entry of a command to power off the drive motor 226 in response to the second 5-cycle count. Next, a coded communication indicating that the following communication signal will identify a specific recipient for a subsequent communication signal in response to the 10-cycle count. In this case, the next cycle count of the communication signal is 10. This second 10-cycle count indicates that the cart 104 identified as cart 104 number 10 is the only cart 104 that will store the following coded communication from the communication signal. Therefore, cart 104 number 10 stores the coded communication to power off in response to the 9-cycle count. Next, a zero-cycle count corresponds to a communication signal to “wake-up” all the carts 104 to start storing the coded communications again. Finally, an “execute” coded communication, (i.e., a 1-cycle count) is received by the carts 104. In response, the cart-computing devices 228 begin to execute the coded communications in each of their lists in the order in which they were received.

As a result, all the carts 104 will operate their drive motors 226 in a forward direction for 20 seconds, power off their drive motors 226, operate their drive motors 226 in a reverse direction for 5 seconds, and then cart 104 number 10 will power off. This is only one example of communication that may be achieved between a signal generating circuit 142 (and/or master controller 106 and/or other carts 104) that is communicatively coupled to one or more carts 104 on a track 102. Additional coded communications may be implemented to provide additional functional and communication structures between a cart 104 and a master controller 106 or a cart 104 and other carts 104 on the track 102. The aforementioned is only an example, other coded communications or communication techniques may be employed using the communication system described herein. By way of another example, a communication signal may be a packet having a starting command, a code portion, a checksum, and an end, each of which are formed with one or more bits (e.g., binary 0s or 1s). The binary 0s and 1s may be generated through the presence or absence of a trigger signal within the communication signal. That is, a cycle without a trigger signal may be a digital 0 while a cycle with a trigger signal may be a binary 1.

In some embodiments, duplex communication (i.e., communication in two directions at the same time) may be achieved. For example, a master controller 106 sending a communication signal to a cart 104 may utilize the falling edge zero-crossings for the first and second trigger signals and the cart 104 sending a communication signal to the master controller 106 may utilize the rising edge zero-crossings for the first and second trigger signals. As such, two communication signals may be transmitted at the same time over the alternating current electrical signal.

Referring now to FIG. 7C, an alternating current electrical signal 770 with communication signals 771 and 774 embedded through modified peak voltage values is depicted. In some embodiments, the communication signal (e.g., 771) is generated by modifying the peak voltage values of the first and second trigger signals and each of the cycles therein. For example, a first communication signal 771 includes a first trigger signal 772 and a second trigger signal 773. The first trigger signal 772 is generated by reducing the amplitude of the positive peak voltage and the negative peak voltage of the alternating current electrical signal 770. Similarly, the second trigger signal 773 is generated by reducing the amplitude of the positive peak voltage and/or the negative peak voltage of the alternating current electrical signal 770. In such embodiments, the signal generating circuit 142 may modify the peak voltage of the alternating current electrical signal 770 to indicate the beginning and end of the communication signal 771 and 774 or represent a binary 0 or 1. In some embodiments, the signal generating circuit 142 may reduce the amplitude of the peak voltage of an alternating current electrical signal 770 by applying an additional load or using a clipping circuit. In some embodiments, a transformer with taps configured to adjust the output voltage may be used and the signal generating circuit 142 may selectively connect a tap, which reduces the amplitude of the peak voltage of the alternating current electrical signal 770. In some embodiments, the master controller 106 may operate as the signal generating circuit 142. For example, the master controller 106 may generate a signal to control the tap selection of the electrical power source 140, thereby adjusting the peak voltage level of the alternating current electrical signal 770 that is output by the electrical power source 140.

However, in order to maintain electrical power to the track 102, the amplitude of the peak voltage may not be reduced below an operating voltage level. For example, if the system rectifies and regulates an 18-volt alternating current electrical signal 770 into a 12-volt DC signal for use, for example, with electronics on a cart 104, then the operating voltage (e.g., peak voltage) may remain above a value that can provide the 12-volt DC signal. In some embodiments, the peak voltage of an alternating current electrical signal 770 may be 18-volts and the minimum operating voltage to maintain operation of the carts 104 on the track 102 may be 12-volts. Therefore, a trigger voltage level may be a value between 18-volts and 12-volts, for example, 14-volts. As illustrated in FIG. 7C, communication signals 771 and 773 include a reduced peak voltage (Vₚₑₐₖ and −Vₚₑₐₖ) to a trigger voltage level (V_{trig} and −V_{trig}), which remains above an operating voltage minimum level (Vₒₚ and −Vₒₚ). Therefore, a communication signal may be transmitted with the alternating current electrical signal 770 without disrupting the electrical power provided to the track 102.

Referring to FIG. 7D, another alternating current electrical signal 780 with communication signals 781 and 784 embedded within through modified peak voltage values is depicted. The communication signals 781 and 784 depicted in FIG. 7D may be generated by a signal generating circuit 142 and/or master controller 106. In the embodiment depicted in FIG. 7D the communication signal 781 includes a first trigger signal 782 generated by reducing the amplitude of the positive peak voltage of the alternating current electrical signal 780. Similarly, the second trigger signal 783 of the first communication signal is also generated by reducing the amplitude of the positive peak voltage of the alternating current electrical signal 780. Although the embodiment depicted in FIG. 7D illustrates the amplitude of the positive peak voltage being reduced to generate a first and second trigger signal 782 and 783 for the first communication signal, it should be understood that the amplitude of the positive peak voltage and/or the amplitude of the negative peak voltage may be reduced to generate the first and second trigger signal 782 and 783.

In some embodiments, a duplex communication signal may be achieved by providing one trigger signal that includes a first and second trigger signal having reduced amplitudes of the positive peak voltages and a second communication signal that includes a first and second trigger signal having reduced amplitude of the negative peak voltages. In such an embodiment, a master controller 106 may communicate with a cart 104 and a cart 104 may simultaneously communicate with the master controller 106.

Referring to FIG. 7E, another alternating current electrical signal 790 with communication signals embedded within the alternating current electrical signal 790 is depicted. In some embodiments, the communication signals may be embedded within the alternating current electrical signal 790 by momentarily adjusting or delaying the voltage level of the electrical signal near the zero-crossing. For example, the communication signal may include a trigger signal 792, which momentarily holds the voltage of the alternating current electrical signal 790 steady or at least changes the rising or decreasing slope of the alternating current electrical signal 790. In operation, a computing device (e.g., a master controller 106 or a cart-computing device 228) may anticipate the occurrence of the zero-crossing of the alternating current electrical signal 790 based on the oscillating frequency of the alternating current electrical signal 790. As such, when there is a delay to the occurrence of the zero-crossing, the computing device may determine that a trigger signal 792 has been transmitted. In other embodiments, the momentary adjustment in the otherwise consistent increase and decrease in the slope of the voltage of the alternating current electrical signal 790 may be detected by the computing device as the trigger signal 792.

As discussed herein, the trigger signal may indicate the beginning or the end of a communication signal where the number of cycles therebetween corresponds to a particular communication signal. However, the trigger signal and the absence of a trigger signal may represent a binary-based communication signal. For example, a trigger signal may represent a binary value of “1” and the absence of a trigger signal may represent a binary value of “0.” As such, communication signals may be encoded within the alternating current electrical signal utilizing binary encoded messages.

It should now be understood that communication signals may be embedded within an alternating current electrical signal utilizing a first and second trigger signal and the number of cycles of the alternating current electrical signal, which occur between the first and second trigger signal. The number of cycles may correspond to a coded communication that translate to an instruction, data, an ID (e.g., address) of an intended recipient, a control signal or the like.

FIG. 8 depicts a flowchart for providing a communication signal within an alternating current electrical signal. As illustrated in block 802, the content of a communication signal may be determined. The content of the communication signal may be a coded communication representing, for example, an instruction, data, an ID of an intended recipient, a control signal, or the like. The content corresponds to an action that the cart 104 or master controller 106 may complete. For example, the action may comprise advancing the cart 104 a predefined distance along the track 102. In block 804, the content of the communication signal may be translated into one or more coded communications. Following the example action of advancing the cart 104 a predefined distance along the track 102, the one or more coded communications for the cart 104 to complete the action may include a first coded communication for powering on the drive motor 226 and a second coded communication for communicating an instruction for powering off the driver motor after a predefined period of time. For example, a two-cycle count (i.e., the predetermined number of cycles of the alternating current electrical signal) may correspond to an instruction for powering on the drive motor 226 and an eight-cycle count may correspond to an instruction for powering off the driver motor after a predefined period of time. In some embodiments, such as the one in this example, there may be more than one coded communication for completing an action. In other embodiments, a series of actions may also be combined to form a program for the cart 104 and/or master controller 106 to follow. As such, in block 806, the one or more coded communications may be added to a queue for transmission. The queue may represent a series of commands which make-up the action or a program which includes more than one action for the cart 104 and/or the master controller 106 to carry out.

In block 808, a coded communication from the queue may be selected and a first trigger signal indicating the beginning of the communication signal is generated. The signal generating circuit 142, for example, in block 810, may then monitor and/or count the number of cycles of the alternating current electrical signal that have propagated since the first trigger signal. When the number of cycles of the electrical signal corresponding to the coded communication has propagated from the electrical power source 140, a second trigger signal indicating the end of the communication signal may be generated, in block 812, by the signal generating circuit 142. For example, when two cycles of the electrical signal are determined to have propagated, such as when sending the coded communication to turn on the drive motor power, then a second trigger signal is generated to indicate the completion of that communication signal.

Block 814 may then determine whether all of the coded communications in the queue have been transmitted. If not, block 816 selects the next coded communication (e.g., the second coded communication corresponding to an instruction for powering off the driver motor after a predefined period of time) from the queue and returns the method to block 808 for transmitting the next coded communication (e.g., the second coded communication). If all the coded communications in the queue have been transmitted then the embedding of communication signals in the electrical signal may end until a new action for communication is generated.

As illustrated above, various embodiments of systems and methods for providing a cart for a grow pod are disclosed. More particularly, some embodiments disclosed herein include systems and methods of providing and communicating between and with carts in an assembly line grow pod. These embodiments allow for a plurality of carts to operate independently and traverse a track of a grow pod.

Accordingly, embodiments include systems and/or methods for communicating between carts and with a master controller with communication signals embedded within an alternating current electrical signal utilizing a first and second trigger signal and the number of cycles of the alternating current electrical signal, which occur between the first and second trigger signal. The number of cycles corresponds to a coded communication that translates to an instruction, data, an ID of an intended recipient, a control signal or the like. The first and second trigger signal of a communication signal may be implemented by inducing a pulse voltage during zero-crossings of the alternating current electrical signal or reducing the amplitude of the peak voltage of the alternating current electrical signal. Additionally, the first and second trigger signal may be generated by a signal generating circuit electrically coupled to the electrical power source.

It is understood that, although the terms “first,” “second,” “third,” “leading,” “middle,” “trailing,” etc. may be used herein to describe various elements, signals, components, and/or sections, these elements, signals, components, and/or sections, should not be limited by these terms. These terms are only used to distinguish one element, signal, component, and/or section from another element, signal, component, and/or section.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for communicating with a cart. It should also be understood that these embodiments are merely exemplary and are not intended to limit the scope of this disclosure.

What is claimed is:

1. A system comprising:
a length of track having one or more conductive rails;
a signal generating circuit electrically coupled to the one or more conductive rails of the length of track; and
an electrical power source electrically coupled to the one or more conductive rails of the length of track via the signal generating circuit, wherein:
the signal generating circuit includes a power supply for generating a plurality of trigger signals,
the electrical power source provides an alternating current electrical signal to the one or more conductive rails of the length of track via the signal generating circuit,
the signal generating circuit generates a first trigger signal within the alternating current electrical signal at a first time interval and generates a second trigger signal within the alternating current electrical signal at a second time interval,
the first trigger signal corresponds to a beginning of a communication signal and the second trigger signal corresponds to an end of the communication signal,
the communication signal is transmitted over a predetermined number of cycles of the alternating current electrical signal provided by the electrical power source, and
the predetermined number of cycles correspond to a coded communication.

2. The system of claim 1, further comprising a cart comprising:
a wheel supported on the length of track and electrically coupled to the one or more conductive rails of the length of track; and
a cart-computing device communicatively coupled to the wheel, the cart-computing device comprising a processor and a non-transitory computer-readable memory, wherein the non-transitory computer-readable memory comprises a machine-readable instruction set that, when executed, causes the processor to:
detect the first trigger signal transmitted over the one or more conductive rails of the length of track and the wheel of the cart by the signal generating circuit,
detect the second trigger signal transmitted over the one or more conductive rails of the length of track and the wheel of the cart by the signal generating circuit,
determine the predetermined number of cycles of the alternating current electrical signal provided by the electrical power source that occur between the first trigger signal and the second trigger signal, and
determine the coded communication from the predetermined number of cycles.

3. The system of claim 2, wherein the machine-readable instruction set, when executed, further causes the processor to: determine the predetermined number of cycles of the alternating current electrical signal based on a number of zero-crossings of the alternating current electrical signal that occur between the first trigger signal and the second trigger signal.

4. The system of claim 2, wherein:
the cart further comprises a drive motor rotatably coupled to the wheel such that an output of the drive motor propels the cart along the length of track and the drive motor electrically couples to the one or more conductive rails of the length of track via the wheel;
the cart-computing device is communicatively coupled to the drive motor, and
the machine-readable instruction set, when executed, further causes the processor to generate and transmit a control signal to the drive motor to cause the drive motor to operate in response to the coded communication.

5. The system of claim 1, further comprising a master controller communicatively coupled to the signal generating circuit, the master controller comprising a processor and a non-transitory computer-readable memory, wherein the non-transitory computer-readable memory comprises a machine-readable instruction set that, when executed, causes the processor to:
determine an action,
encode an instruction to complete the action in the coded communication, and
direct the signal generating circuit to generate the first trigger signal and the second trigger signal such that the coded communication contains the instruction.

6. The system of claim 1, wherein the first trigger signal comprises a first voltage pulse generated by the signal generating circuit during a first zero-crossing of the alternating current electrical signal and the second trigger signal comprises a second voltage pulse generated by the signal generating circuit during a subsequent zero-crossing of the alternating current electrical signal.

7. The system of claim 1, wherein the alternating current electrical signal comprises a positive peak voltage and a negative peak voltage, and the signal generating circuit generates the first trigger signal by reducing an amplitude of the positive peak voltage, the negative peak voltage, or both the positive peak voltage and the negative peak voltage to a trigger voltage level for one cycle of the alternating current electrical signal.

8. The system of claim 7, wherein the signal generating circuit generates the second trigger signal by reducing the amplitude of the positive peak voltage, the negative peak voltage, or both the positive peak voltage and the negative peak voltage to the trigger voltage level for one cycle of the alternating current electrical signal subsequent to the first trigger signal.

9. The system of claim 8, wherein the trigger voltage level of the first trigger signal is greater than an operating voltage of a cart receiving the alternating current electrical signal such that operation of the cart continues uninterrupted.

10. The system of claim 1, wherein the alternating current electrical signal comprises a positive peak voltage and a negative peak voltage, the signal generating circuit generates the first trigger signal by reducing an amplitude of the positive peak voltage, the negative peak voltage, or both the positive peak voltage and the negative peak voltage to a trigger voltage level for each cycle of the alternating current electrical signal of the communication signal until the signal generating circuit generates the second trigger signal by returning the alternating current electrical signal to the positive peak voltage and the negative peak voltage output by the electrical power source.

11. The system of claim 10, wherein the trigger voltage level of the first trigger signal is greater than an operating voltage of a cart receiving the alternating current electrical signal such that operation of the cart continues uninterrupted.

12. The system of claim 1, further comprising an assembly line grow pod having a plurality of carts for growing a plurality of plants, wherein the length of track is part of the assembly line grow pod and the plurality of carts are supported on the length of track.

13. A system comprising:
a length of track having one or more conductive rails;
an electrical power source electrically coupled to the one or more conductive rails of the length of track; and
a cart comprising:
one or more first wheels supported on the length of track and electrically coupled to the one or more conductive rails of the length of track,
a cart-computing device communicatively coupled to the one or more first wheels, and
a signal generating circuit electrically coupled to the cart-computing device and the one or more first wheels, wherein:
the signal generating circuit includes a power supply for generating a plurality of trigger signals,
the electrical power source provides an alternating current electrical signal to the one or more conductive rails of the length of track,
the signal generating circuit generates a first trigger signal within the alternating current electrical signal at a first time interval and generates a second trigger signal within the alternating current electrical signal at a second time interval,
the first trigger signal corresponds to a beginning of a communication signal and the second trigger signal corresponds to an end of the communication signal,
the communication signal is transmitted over a predetermined number of cycles of the alternating current electrical signal provided by the electrical power source, and
the predetermined number of cycles correspond to a coded communication.

14. The system of claim 13, wherein the first trigger signal comprises a first voltage pulse generated by the signal generating circuit during a first zero-crossing of the alternating current electrical signal and the second trigger signal comprises a second voltage pulse generated by the signal generating circuit during a subsequent zero-crossing of the alternating current electrical signal.

15. The system of claim 13, further comprising a master controller communicatively coupled to the one or more conductive rails of the length of track, the master controller comprising a processor and a non-transitory computer-readable memory, wherein the non-transitory computer-readable memory comprises a machine-readable instruction set that, when executed, causes the processor to:
detect the first trigger signal transmitted over the one or more conductive rails of the length of track and the one or more first wheels of the cart by the signal generating circuit,
detect the second trigger signal transmitted over the one or more conductive rails of the length of track and the one or more first wheels of the cart by the signal generating circuit,
determine the predetermined number of cycles of the alternating current electrical signal provided by the electrical power source that occur between the first trigger signal and the second trigger signal, and
determine the coded communication from the predetermined number of cycles.

16. The system of claim 15, wherein the communication signal corresponds to a status information of the cart.

17. The system of claim 13, further comprising a second cart comprising:
one or more second wheels supported on the length of track and electrically coupled to the one or more conductive rails of the length of track,
a second cart-computing device communicatively coupled to the one or more second wheels, the cart-computing device of the second cart comprising a processor and a non-transitory computer-readable memory, wherein the non-transitory computer-readable memory comprises a machine-readable instruction set that, when executed, causes the processor to:
detect the first trigger signal transmitted over the one or more conductive rails of the length of track and the one or more second wheels of the cart by the signal generating circuit,
detect the second trigger signal transmitted over the one or more conductive rails of the length of track and the one or more second wheels of the cart by the signal generating circuit,
determine the predetermined number of cycles of the alternating current electrical signal provided by the electrical power source occurring between the first trigger signal and the second trigger signal, and
determine the coded communication corresponding to the predetermined number of cycles.

18. The system of claim 17, wherein the communication signal corresponds to a control signal for controlling an operation of a drive motor of the second cart supported on the length of track.

19. A method for communicating via an alternating current electrical signal from a master controller to a cart supported on a length of track in an assembly line grow pod, the method comprising:
determining, by the master controller, an action to be completed by the cart;
generating one or more coded communications for the action;
generating a first trigger signal within the alternating current electrical signal from an electrical power source;
determining when a predetermined number of cycles of the alternating current electrical signal corresponding to a coded communication of the one or more coded communications have propagated from the electrical power source following the first trigger signal;
generating a second trigger signal within the alternating current electrical signal when the predetermined number of cycles of the alternating current electrical signal corresponding to the coded communication have propagated following the first trigger signal.

20. The method of claim 19, wherein the one or more coded communications for the cart to complete the action include a first coded communication for powering on a drive motor and a second coded communication for communicating a predefined period of time to power on the drive motor to cause the cart to advance along the length of track.
